(19) United States
(12) Patent Application Publication
(10) Pub. No.: US 2011/0135277 A1
(43) Pub. Date: Jun. 9, 2011

(54) Method and Apparatus for Providing in a Receiver a Copy Protection Signal That Negates a Circumvention Device and or Provides Improved Playability

(75) Inventor: Ronald Quan, Cupertino, CA (US)

(73) Assignee: Rovi Technologies Corporation

(21) Appl. No.: 12/634,566

(22) Filed: Dec. 9, 2009

(51) Int. Cl. H04N 5/91; H04N 9/80; H04N 5/931

(52) U.S. Cl. 386/256; 386/E05.004; 386/204

(57) ABSTRACT

A receiving device provides a “new” copy protection signal which causes resistance to certain circumvention devices and includes improved playability. The new copy protection signal causes the certain circumvention devices to pass substantially the copy protection effects to a video recorder, or causes content control effectiveness on a compliant device. That is, the new copy protection signal from the receiver causes the circumvention device to add or enhance copy protection effectiveness, which is contrary to the circumvention device's original intent of removing or reducing copy protection effectiveness. The new copy protection signal is provided by inserting or adding one or more pseudo sync pulses or one or more pseudo sync/AGC pulse pairs immediately after, one line after, or less than two and a half lines after, a vertical sync signal in at least one television line. Thus, the receiver utilizes the new copy protection signal to thwart various intended functions of the circumvention device.

### CROSS-REFERENCE TO RELATED APPLICATION

The present invention is related to U.S. patent application Ser. No. 12/322,004 titled “Method And Apparatus For Synthesizing Copy Protection For Reducing/Defeating the Effectiveness or Capability of a Circumvention Device,” filed on Jan. 28, 2009, U.S. patent application Ser. No. 12/583,834 titled “Method and Apparatus for Providing in a Media Player a Copy Protection Signal that Negates a Circumvention Device and or Provides Improved Playability,” filed on Aug. 26, 2009, and U.S. Provisional Ser. No. 61/190,254 filed on Aug. 27, 2008, which are all incorporated by reference.

### BACKGROUND

The present invention relates to receiving devices in combination with video copy protection signals, wherein the copy protected video signals are playable but not recordable. More particularly, the invention relates to receiving devices, which include set top boxes, IPTV devices, cell phones, digital media extending devices, which receive video programs via a digital signal.

In previous technologies, receiving devices or the like, have used control bits in the digital bit stream to program or to command a predetermined copy protection signal to inhibit copying, while allowing display on a monitor. Such copy protection processes hamper or inhibit recording as, for example, on a video cassette recorder (VCR) or personal video recorder (PVR). Until now, the copy protection signals have been susceptible to circumvention devices which remove or reduce the copy protection effectiveness.

In the field of anti-copy protection signals, negative going pulses are paired with positive going pulses. For example, pseudo sync and automatic gain control (AGC) pulses and or sync pulses and AGC pulses constitute signals that cause a reaction in AGC systems in a VCR, or are detected by a reading system in a compliant device such as a PVR, digital recorder, or analog to digital convertor. In general, a video anti-copy protection process, such as a copy protected video signal or a video signal including one or more copy protection signal such as pseudo sync/AGC pulses, is playable on a television (TV) display while generally causing darkening, color distortion, tearing, loss in at least a portion of a program video signal or video gain effects, in a recorded copy.

However, such signals have been circumvented by circumvention devices, commonly referred to as “black box” devices, which remove or attenuate the effects of the anti-copy protection pulses, while passing the (active field) program video intact. Such “black boxes” generally replace the negative (e.g., pseudo sync) and or positive going pulses (e.g. AGC pulses/signals) with a blanking level or with newly regenerated sync pulses free of pseudo sync/AGC signals.

A copy protection process disclosed in U.S. Pat. No. 4,631,603, John O. Ryan, December 1986, assigned to Macrovision Corporation, Santa Clara, Calif., incorporated by reference, is well known to have placed pseudo sync and AGC pulses in specific television (TV) lines for pre-recorded video home systems (VHS) tape and digital video disc (DVD) playback devices. These pseudo sync/AGC pulses inserted in a program video signal prohibit recording by affecting the AGC system of a recorder, while allowing (substantially) normal display of the program video signal. However, the makers of the circumvention devices have observed the locations of the added pulses in the vertical blanking interval (VB1), and accordingly have generated a timing pulse to blank out or to modify at least some of the copy protection signals.

Several of the newer circumvention devices do away with conventional timing circuits and rely on microprocessors to provide the blanking pulses. Other circumvention devices utilize traditional timing circuits (e.g., retriggerable one shot) to locate the copy protection pulses.

Also, in the field of copy protection, the anti-copy protection signals are usually hidden in a portion of the vertical blanking interval, which generally cause a small scanning error in the display device. But because most displays overscan the video information, which results in a cropped picture, the scanning error is generally not noticeable. However, with some displays with less overscan, a small but perceivable geometric distortion may be observed when certain anti-copy protection signals are applied in the vertical blanking interval.

### SUMMARY

One embodiment of the invention provides a receiver, which may include a set top box, computer, cell phone, IPTV device (Internet Protocol), or the like, to output a “new” copy protection signal (which is normally playable on a TV set) that includes one or more signals that provides resistance to certain circumvention devices. Generally, an analog output of the receiver is coupled to an input of the circumvention device. Providing “resistance” to a circumvention device may include causing the circumvention device to pass at its output sufficient copy protection pulses to enable copy protection (e.g., effect) on a recorder, and or cause the circumvention device to add enhancement to the copy protection effectiveness (e.g., the “new” copy protection signal causes the circumvention device to blank a portion of the active field of the program video source.)

One typical example includes a receiver (with a digital and or analog signal coupled to an input of the receiver) that outputs the copy protection signal, along with a video program signal, which is then coupled to an input of a circumvention device. The output of the circumvention device is coupled to a TV set or to a recorder and display. In this embodiment of the invention, the signal from the receiver's analog output causes the circumvention device to blank out a portion of the (program) video signal. Thus the circumvention device is thereby causing playbility problems when the output of the circumvention device is coupled to a TV set. When the output of the circumvention device is coupled to an input of a VCR, the VCR produces a low output video signal (or produces distorted picture) at the VCR output, as when an illegal recording is played back from the VCR. Moreover, when the output of the circumvention device is coupled to a compliant recorder or content control system, record control or content control is not circumvented by the black box, but instead recording is disabled or the content control system is enabled.

In some circumvention devices it was found experimentally that the black boxes of previous mention can be disabled by observing the behavior of the microprocessors or certain traditional timing circuits in the black boxes, while still providing an effective anti-copy protection signal at the output of the device. To reiterate, an anti-copy protection signal or video copy protected signal is playable on a TV display, while prohibiting recording, such as by causing an erroneous signal level by affecting an AGC system in a recorder, which causes picture darkening, changes in contrast and or brightness levels. Unlike a scrambled video signal, which is not playable on a TV display, a copy protected video signal is displayed normally (e.g., with few or negligible or zero artifacts). In general, a video copy protection signal (or anti-copy protection signal) is provided, added, and or inserted to a video signal to produce/provide a copy protected video signal.

Thus, an intention of the receiving device, in combination with copy protection signals of description herein, is to neutralize or reduce the effectiveness of circumvention devices, while maintaining and or enhancing a copy protection effect, thereby providing a novel expansion for media players or DVD players. Accordingly, it is desirable to provide, generate, or synthesize a video copy protection signal which, in combination with receiving devices, in effect thwarts one or more intended functions of a circumvention device. For example, when a black box is used to circumvent copy protection signals output from a receiver, the receiver's analog output signal is coupled to the input of the circumvention device. The output of the circumvention device is then coupled to a recorder or compliant device or TV set. When the receiver includes a copy protection signal that provides resistance to the circumvention device in accordance with the invention, the circumvention device will then (instead) allow passage of sufficient copy protection signals (e.g., pseudo sync, AGC pulses, and or color stripe signals) for a content control device to still work properly (e.g., prohibit, limit, or restrict recording) or for a VCR's AGC system to react in a manner to provide a degraded signal. That is, in response to the copy protection signal that provides resistance to the circumvention device, the circumvention device “unwittingly” increases/enhances the copy protection effect by blanking/distorting a portion of the active field (e.g., color burst and or program video near the top of the viewable frame/field).

Accordingly, one effect is to cause a circumvention device to allow the passage therethrough of a number of copy protection pulses or signals such that a VCR still reacts to the copy protection signals following the circumvention device. Another effect is to provide a copy protection signal such that when it is supplied to a circumvention device, the output of the circumvention device, contrary to its intended function, still provides a detectable copy protection signal to a compliant video recorder or compliant device.

Yet another effect is to synthesize a copy protection signal such that when coupled to a circumvention device, the output of the circumvention device causes playability problems in a display, or increased copy protection effect(s) such as blanking out a portion of the viewable area and or causing chroma artifacts.

The above mentioned effects can be implemented in a number of ways such as by moving, adding, or shifting anti-copy protection signals toward the vertical sync signal (e.g., in a 525 or 625 line TV standard) so as to provide the copy protection signal. Alternatively, the effects can be implemented by synthesizing an anti-copy protection signal such that there is no more than one video line free of negative going pulse(s) between one horizontal blanking interval to a next horizontal blanking interval (e.g., one or more pseudo sync pulse is provided between lines).

An embodiment of a receiving device/copy protection signal combination of the invention, improves playability in terms of reducing hooking that can be viewable in some monitors on the top portion of their displays. In particular, an embodiment of the invention includes a copy protection process comprised of Format A and Format B, wherein the formats are interleaved from one TV line to another. Because the formats have in general different positions of pseudo sync pulses or different numbers or pseudo sync pulses for each format, a TV scanning system's phase lock loop system can be excited into causing errors in scanning. By shifting the pseudo sync pulses of the Format A and Format B copy protection signals closer to the vertical sync signal area or away from the active field, the phase lock loop system is allowed to settle in such a way that playability is improved or that a scanning error is reduced. Alternatively, the playability is improved when Format A equals Format B, when the copy protection signals are shifted away from the active field, or when the copy protection signals are moved closer to the vertical sync signal in the vertical blanking interval (VBI).

Another embodiment of the invention provides a copy protection signal of improved playability, wherein the copy protection signal includes pseudo sync signals and provides in TV lines the pseudo sync signals located away from the active video field or closer to the vertical sync signal, wherein the (newly located or provided) pseudo sync signals provide less scanning errors or geometric distortion on a TV set. As described above, the pseudo sync signals may have (same or) different number of pseudo sync pulses from one TV line to another or (same or) different pseudo sync pulse width from one TV line to another line.

A further embodiment includes providing improved playability of a copy protection signal, wherein the copy protection signal includes pseudo sync pulses (or pulse pair signals of pseudo sync and AGC signals) of a different number of pseudo sync pulses (or pseudo sync and AGC signals) from one TV line to another line and or different pseudo sync (or pseudo sync and AGC) pulse widths from one TV line to another. This embodiment includes modifying or providing at least one TV line to provide at least two lines consecutively with substantially the same number of pseudo sync pulses and or substantially the same pseudo sync pulse width. It should be noted that the resulting copy protection signal may still include an alternating pattern or format of a number of pseudo sync pulses and or pseudo sync pulse widths from one line to another.

By way of example, an embodiment of the invention may have (in a 625 line standard such as, for example, PAL or Secam) a Format A, which has 7 (or 6 or at least 1) pseudo sync or AGC pulses on video line 7 (or 6), followed by Format B, which has 6 (or 7 or at least 1) pseudo sync or AGC pulses on video line 8 (or 7). This example embodiment provides resistance to the intended function of a circumvention device by, for example, causing the black box to blank color burst in a portion of the active field, causing the circumvention device (black box) to remove or modify program video in an active portion of the TV field, and or causing the circumvention device to allow the passage of at least some or all of copy protection signals in a TV field. This embodiment also may provide improved playability of the program video signal.

Similarly, in a 525 line standard (e.g., NTSC or PAL-M), another embodiment of the invention provides one or more (e.g., 4) pseudo sync pulses or pseudo sync and AGC pulses (e.g., starting) at line(s) 10, 11, 272, and or 273. In this embodiment of a 525 line standard, resistance to a circumvention device is provided, for example, by causing the circumvention device to pass some or all of the copy protection signals to provide a copy protection or content control effect, whereas the circumvention device's intended function is to remove the copy protection signal to defeat a copy protection or content control effect. In an embodiment of the invention, an existing 525 line copy protection process may already have a line with pseudo sync pulses after a post equalizing pulse or vertical sync signal in one field, thereby causing a circumvention device to pass the copy protection process in one field while blanking out copy protection signals in another field, which provides a partial (e.g., about half) resistance to the circumvention device. The receiver may program or provide placing pseudo sync pulses after both fields after a post equalizing pulse or vertical sync signal (e.g., provide pseudo sync pulses in lines 10 and 272, or line 10 in field 1 and line 9 in field 2) to provide for more resistance (e.g., more than half, such as full) to the circumvention device.

In another example of the embodiment, an existing copy protection process may have partial resistance to a circumvention device by providing pseudo sync pulses on line 10 of field 1 but no resistance to the black box by placing pseudo syncs in line 10 of field 2 (line 273=line 10 of field 2). Further, an embodiment of the invention places one or more pseudo sync pulse on line 9 of field 2 (line 272), while on field 1, one or more pseudo sync pulse may be placed on line 10 and or 11. An embodiment of the invention may program the receiver to provide partial resistance on a circumvention device such as providing resistance on an even field (e.g., field 2, provide pseudo sync on line 9 or 272), while not providing resistance on and odd field (e.g., field 1, provide pseudo sync on line 11 or after), or vice versa.

The 525 or 625 line standard embodiments of previous example provide improved playability for a signal of the copy protection process (or for a content control signal), for example, in terms of reduced geometric distortion in a display.

Generally, in receivers, the transmission signal or signal into the receiver may include a bit pattern, and or control bit(s), such as APS bit(s), trigger bits, or one or more flag signals. The control bits command/provide/program (e.g., to enable, disable, provide, modify, and or program) or select a particular version of the copy protection signals of previous description herein (or content control or copy protection signals described hereafter), to provide resistance to circumvention devices or provide improved playability, in accordance with the invention. It should be noted that a bit pattern or control bit(s) may be provide by way of metadata and or watermarked signal. For example, metadata that normally provides information on program material (e.g., movies, TV programs, audio and or video files, or the like) can be used to command/provide/program any copy protection or content control signals described in this invention. A watermark video or audio signal may also convey information for providing a bit pattern or control bit(s) as previously described. Here for example, the a watermarked signal in a video signal's image area or a watermarked signal embedded in an audio program signal can provide one or more bits to command/provide/program for any content control or copy protection signal described in this invention.

In accordance with the invention, a receiver (i.e., receiving device) including a tuner, may alternatively command or select one of such copy protection signals via control bit(s) or bit(s) from a transmission link, authorization code, remote control, hardware (e.g., jumper or switch), software, or other methods different from receiving a bit from the recorded or stored medium. Further, such a copy protection signal may be activated or deactivated in the receiving device, or in the circuit board and or chip within the receiving device.

Accordingly, the invention pertains to receivers that provide one or more of the copy protection signals and or video signal modifications of description herein, which receivers include a link to a digital network, Internet, cable, telephone (network), wireless router/server/connection or the like, and may include further storage via optical, solid state, or magnetic methods for playing back recorded video/audio programs.

### BRIEF DESCRIPTION OF THE DRAWINGS

FIGS. 1A and 1B are waveforms illustrating examples of prior art copy protection signals.

FIG. 1C are waveforms of video line locations for a 525 line TV standard such as NTSC.

FIGS. 2A and 2B are waveforms illustrating examples of one or more waveforms for combination with receiving devices of the invention.

FIG. 3A is a block diagram illustrating a prior art circumvention (“black box”) device.

FIG. 3B is a block diagram illustrating a timing circuit including a microprocessor device for a circumvention device.

FIG. 3C is a block diagram illustrating a timing circuit including a retriggerable circuit for a circumvention device.

FIG. 4A illustrates the line locations of two prior art copy protection processes within a portion of the vertical blanking interval (VBI) and active field.

FIG. 4B is a waveform illustrating an output of a first timing circuit of a prior art sync separator and timing circuit.

FIG. 4C is a waveform illustrating a blanking or removing pulse triggered by the trailing edge of the waveform in FIG. 4B.

FIG. 5A illustrates the line locations of copy protection signals for an embodiment (e.g., NEW1).

FIG. 5B is a waveform illustrating a blanking or removing pulse derived from timing circuits 22 or 22″ of FIGS. 3A or 3C, respectively.

FIG. 5C is a waveform illustrating a blanking or removing pulse derived from circuit 22′ of FIG. 3B.

FIG. 6A illustrates the line locations of alternative copy protection signals for another embodiment (e.g., NEW2).

FIG. 6B is a waveform illustrating a blanking or removing pulse derived from circuit 22 of FIG. 3A.

FIG. 6C is a waveform illustrating a blanking or removing pulse 12̂ or 12* derived from circuits 22′ or 22″ of FIGS. 3B or 3C, respectively.

FIG. 7 is a waveform illustrating a video signal prior to inserting or adding a copy protection signal.

FIG. 8A is a waveform illustrating a video signal with a prior art copy protection signal.

FIG. 8B is a waveform illustrating an effect of a circumvention device on the video signal of FIG. 8A.

FIG. 9A is a waveform illustrating a video signal with a copy protection signal of an embodiment of the invention.

FIG. 9B is a waveform illustrating an effect of a circumvention device on the video signal of FIG. 9A.

FIG. 10 is a block diagram illustrating an embodiment of the invention comprising a processor, which is coupled to a circumvention device and other equipment.

FIGS. 11A-11D illustrate examples of systems or apparatuses for one or more embodiments for implementing the various waveforms of description herein.

FIGS. 12A-12E illustrate examples of a system operator, digital receiving system, and or receiver which, in accordance with the invention, employ the copy protection signals of description herein.

FIGS. 13, 14, and 15 illustrate various embodiments of the invention.

### DETAILED DESCRIPTION

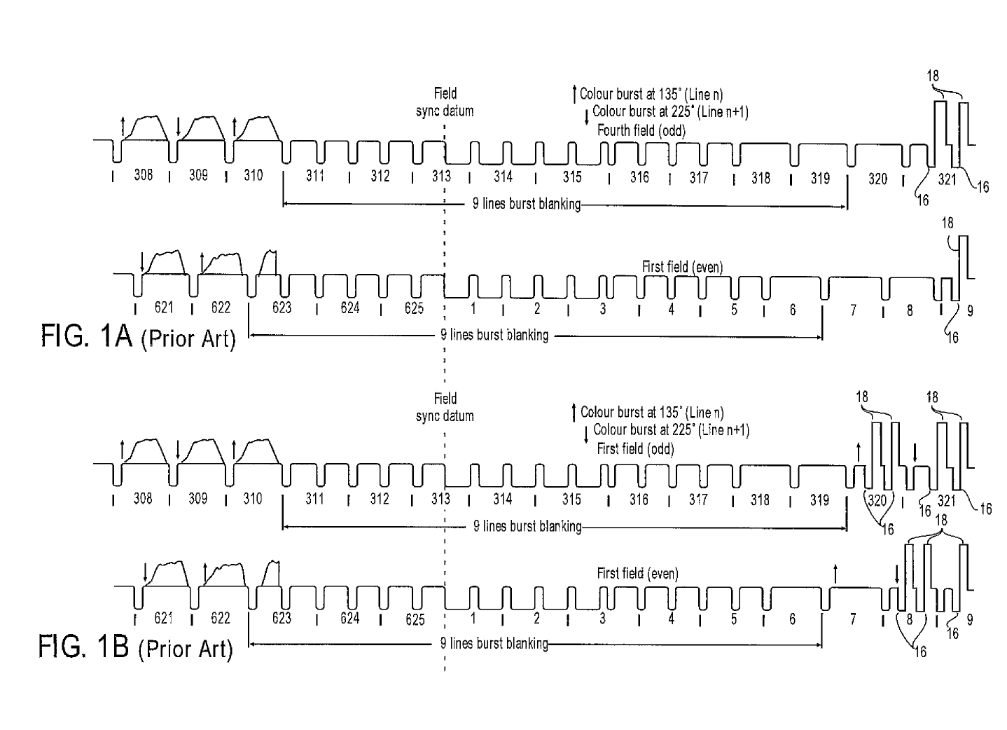

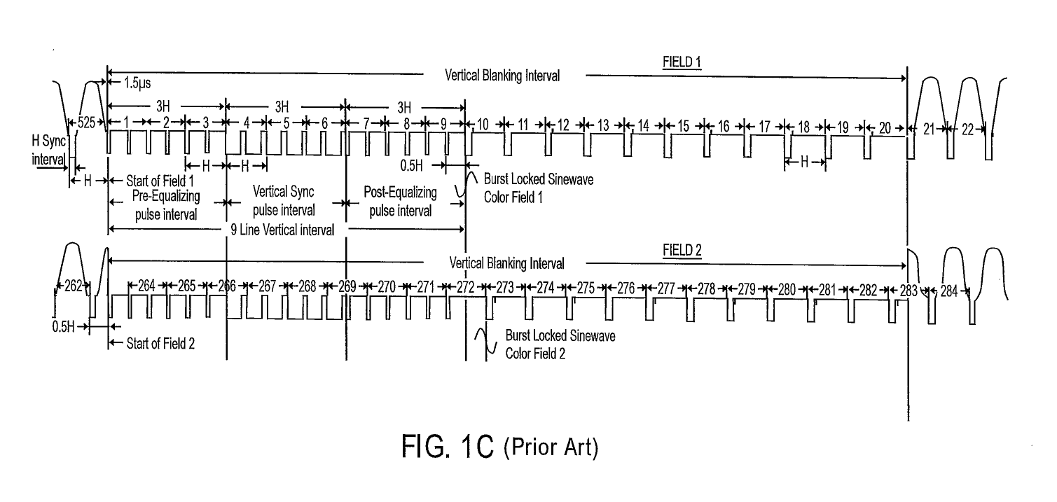

FIG. 1A illustrates a prior art example of a signal in a video home systems (VHS) tape process for providing copy protection employing one or more pseudo sync/AGC (automatic gain control) pulse pairs starting in lines 9 and or 321 for a 625 line standard. Circumvention devices remove one or more of the pseudo sync/AGC pulses to allow a recordable copy. Pseudo syncs pulses are illustrated by numeral 16 and AGC pulses are illustrated by numeral 18 in FIGS. 1A, 1B, 2A, and 2B.

FIG. 1B illustrates a prior art example of a DVD (or tape) process for providing copy protection employing one or more pseudo sync/AGC pulse pairs starting in lines 8 and or 320 for a 625 line standard. Circumvention devices remove one or more of the pseudo sync/AGC pulses to allow a recordable copy.

FIG. 1C illustrates a prior art example of the standard TV line allocation for a 525 TV line standard, NTSC.

FIG. 2A or 2B illustrates an embodiment wherein one or more pseudo sync pulse (or pseudo sync/AGC pulses) is inserted in lines 7 (or 6) and or 319 (or 318) for a 625 line standard example. This particular example of line assignment for pseudo sync (or pseudo sync/AGC) pulses causes some circumvention devices to experience one or more of the following (failures in intended function):

1) Fail in removing one or more copy protection pulses, or still allow an effective copy protection signal or content control signal to be passed to a recorder or compliant device.

2) Fail in providing an improved playable video signal by degrading the video signal via blanking/attenuating/removing a portion of the active field (program) video picture.

3) Fail in providing an improved playable video signal by degrading the video signal via blanking/attenuating/removing at least a portion of color burst in TV lines near or in a portion of the active field (which for example, causes color to unlock at the top of the picture causing color distortion when recorded or played back, or when sent directly to a TV set.).

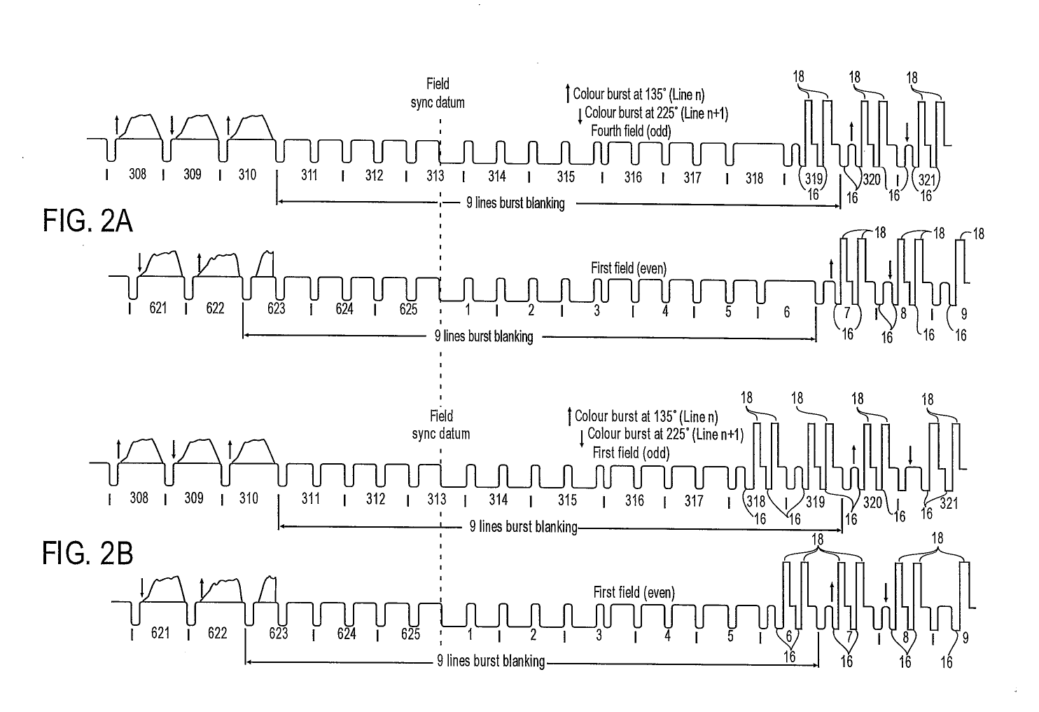

FIG. 3A illustrates a prior art circumvention device (black box), which removes copy protection pulses typically located inside a portion of the vertical blanking interval (VBI). Copy protected video containing typically pseudo sync/AGC pulses as illustrated in FIGS. 1A or 1B is coupled to the input of a sync separator circuit 20. The output of sync separator circuit 20 is coupled to a timing circuit, 22, which provides typically a logic signal coincident with line locations of the input's copy protection signal to a blanker circuit 24. Blanker circuit 24 then removes or replaces the copy protection signals with another signal such as a blanking level, which therefore removes pseudo sync/AGC pulses while passing substantially the video program from the input. This provides a new signal at the output of the blanker circuit 24, whereby the output of circuit 24 provides a recordable signal.

FIG. 3B shows an example of an alternative timing circuit 22′, which uses a microprocessor or computational circuit. Circuit 22′ may provide a signal to the blanker circuit 24 of FIG. 3A via an alternative method. For example, circuit 22′, as found experimentally, may require at least two lines of video that do not have a second (e.g., extra) negative going pulse during an interval of one horizontal line's duration (e.g., 63.55 usec or 64 usec) after the vertical sync signal. An example of this is illustrated in FIG. 1A where the last vertical sync signal ends on line 5, and (three) lines 6, 7, and 8 are free of negative going pulses within a horizontal line duration (before extra negative pulses such as pseudo sync pulses (16) appear on line 9 and other lines beyond). In a standard TV signal for 625 or 525 lines, the vertical sync signal always includes (extra or second) sync pulses that occur at twice the horizontal frequency. This means that one extra pulse is inserted between a TV line interval for the vertical sync signal, which typically includes equalization sync pulses and (serrated) broad pulses or vertical sync pulses. Circuit 22′ senses the one or more extra negative going pulses between a TV line interval (e.g., about 64 microseconds or 63.55 microseconds) to determine the presence of the vertical blanking interval (VBI). After two or more lines which do not include the extra inserted negative going pulse are determined, a blanking pulse is generated.

Similarly in FIG. 1B (two) lines 6 and 7 are free of (extra) negative going pulse(s) within one horizontal line's duration.

Timing circuit 22′ (FIG. 3B) searches for at least a two line gap free of (extra) negative going pulse(s) within a horizontal line duration, and provides a blanking pulse for the removal of the copy protection pulses starting from lines 9 or 8, as illustrated in FIGS. 1A and 1B respectively. Thus, microprocessor timing circuit 22′ has no problem in providing a signal for removal of the copy protection signals, as illustrated in FIGS. 1A or 1B. However, for the waveforms in FIGS. 2A or 2B, the pseudo syncs occur in lines which the microprocessor timing circuit 22′ reads as still part of the vertical sync signal, and thus does not output a signal (e.g., for removal or defeating copy protection signals) until after the last line of copy protection signal (e.g., the last line in the VBI that still has pseudo sync pulses such as line 16, 17 or 18 or beyond). Circuit 22′ reads the pseudo sync pulses as equalizing pulses or some part of the vertical sync signal, and thus is programmed not to remove any pulses or signals resembling a vertical sync signal. Removing a vertical sync signal is prohibited by the microprocessor since this would cause a loss in vertical sync or cause a TV display to unlock field/frame-wise. Thus, careful line location (or placement) of the pseudo sync pulses for a copy protected video signal causes microprocessor timing circuit 22′ to allow passage of at least some or all of the pseudo sync or pseudo sync and AGC pulses to the circumvention device's output (terminal).

FIG. 3C illustrates another timing circuit, 22″, which includes a retriggerable one shot or equivalent. Essentially, circuit 22″ is turned to a high logic level without interruption during the presence of a vertical sync signal in the VBI. For example, if timing circuit 22″ is set to produce a 45 microsecond pulse, then when a vertical sync signal triggers the circuit 22″, a logic signal at the output of circuit 22″ is turned high during the vertical sync signal. The output of timing circuit 22″ is then high continuously because of the pulses between a TV line's interval, which retriggers and causes a high output due to 2 H pulses that are spaced about 31.5 usecs or 32 usecs apart (e.g., pre/post equalizing pulses or serrated (broad) vertical sync pulses) in the vertical sync signal. When one or more pseudo sync pulses is added or provided to TV lines after the post equalizing (2 H) pulses of a vertical sync signal, the one or more pseudo sync pulse also has the same effect on a retriggerable timing circuit as the 2 H pulses. Thus, placement of pseudo sync pulses right after the vertical sync signal or the post equalizing pulse causes the retriggerable circuit to remain high, continuously from the vertical sync signal, until after the last TV line which includes pseudo sync pulses. A circumvention device (black box) that includes this type of retriggerable timing circuit thus will allow passage of some or all of the (newly placed) pseudo sync or copy protection signals to the output of the black box.

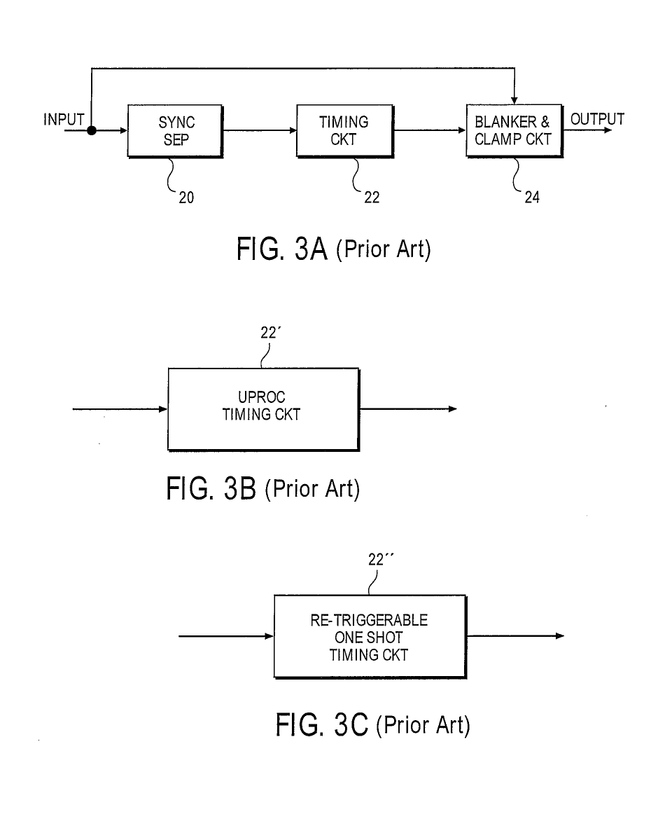

FIG. 4A illustrates a line location of prior art copy protection signals such as anti-copy protection (ACP) in a 625 line standard format. For example, in video lines 8-16, the prior art ACP signal (e.g., for set top boxes or DVD players) is comprised of pseudo sync and AGC pulses. Similarly, for video tape copy protection, the prior art copy protection process is comprised of ACP signals (e.g., pseudo sync and or AGC pulses) from lines 9-18.

Also shown in FIG. 4A is the video line location from a vertical sync signal (e.g., such as including broad vertical sync pulses, and or post equalizing pulses) as lines 1-5 in a 625 (e.g.,. PAL or SECAM) TV standard.

FIG. 4A shows the beginning of the active field of the video signal as line 24 and beyond, and video lines 6 and 7 (or line 8 in a tape process) show that they have no extra negative pulse(s) (NNP).

FIG. 4B illustrates that the vertical sync signal is sensed by circumvention devices, and a timing signal is generated to create a high to low logic signal transition at approximately line 8 of the VBI.

FIG. 4C then shows a pulse which is triggered by the pulse high to low transition of FIG. 4B, wherein the pulse in FIG. 4C is logic high from line 8 to about line 21 (or to at least line 18), which blanks or modifies the ACP signals as seen in FIG. 4A. With the prior art ACP signals of FIG. 4A, any of the timing circuits 22, 22′ and 22″ is effective in removing the ACP signals depicted in FIG. 4A.

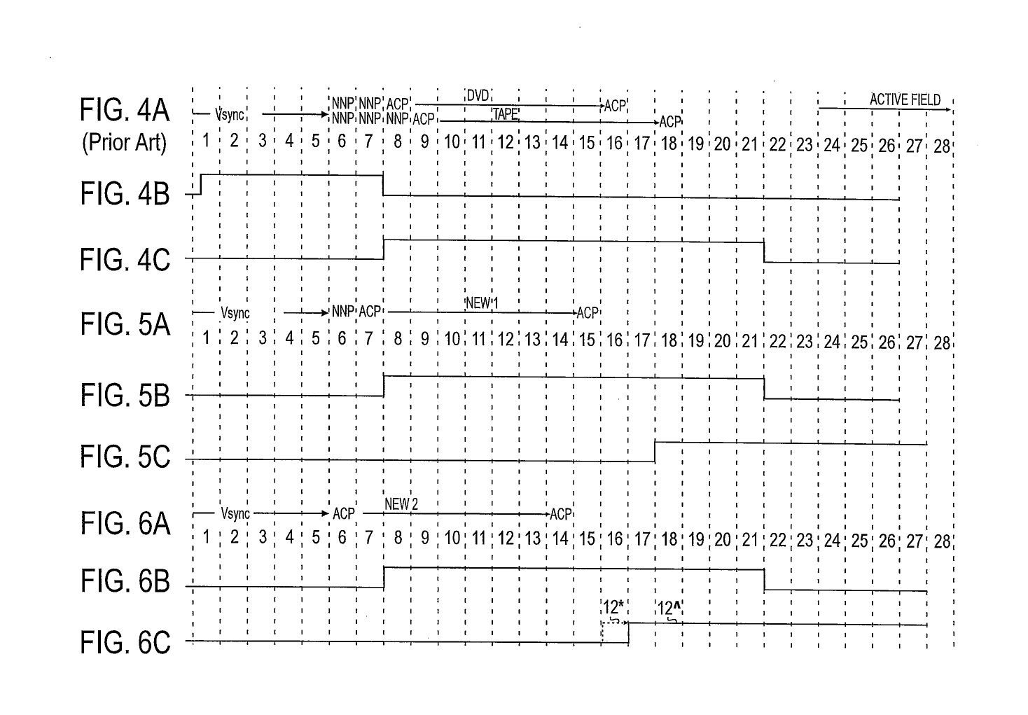

FIG. 5A illustrates an embodiment for providing or synthesizing a new copy protection signal (e.g., NEW1). Here the copy protection signal, which includes negative going pulse(s) (e.g., one or more pseudo sync pulse) and or positive going pulse(s) (e.g., one or more AGC pulse(s)) that is/are inserted in line 7. Note that in this example, there is one video line (e.g., line 6) free of one or more extra negative going pulse after the vertical sync signal. One embodiment includes a one line gap (e.g., line 6) between a vertical sync signal and a copy protection signal including negative going pulse(s).

FIG. 5B illustrates that copy protection pulses are mostly removed by a timing circuit 22 or 22″, which allows the recording of an illegal copy. To the contrary, FIG. 5C shows that the copy protection signals are not removed by timing circuit 22′ (e.g., microprocessor timing circuit). Instead, at least a line (e.g., lines 24 to 27) of the active field is/are removed or blanked out. The reason for the erroneous operation of the circumvention device is because the microprocessor circuit 22′ is expecting at least two lines free of (negative going, equalizing, and or pseudo sync) pulses between two horizontal intervals. In FIG. 5A, the new copy protection signal has only one line free of negative pulses between two horizontal (e.g., blanking) intervals. Recall that the post equalizing sync pulses and pseudo sync pulse(s) are (extra) negative going pulses between two horizontal blanking (or line) intervals.

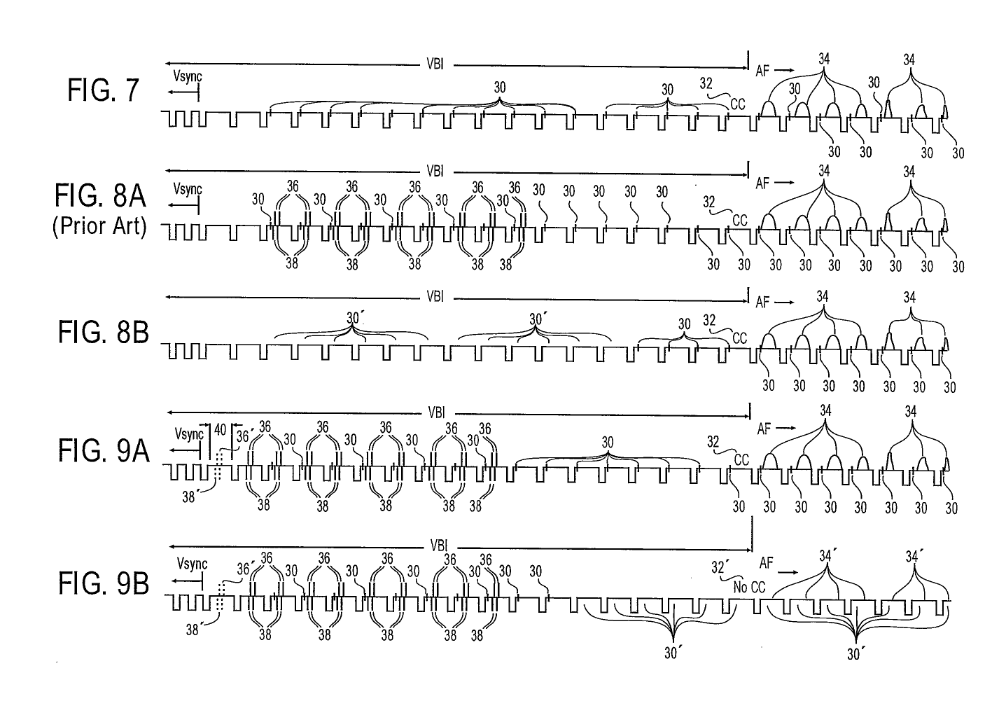

FIG. 6A illustrates another embodiment (e.g., NEW2) where the negative going pulses are added to a line adjacent to the vertical sync signal (e.g., line location of post equalizing pulse(s)). For example, in the PAL standard or 625 TV line standard, the end of the vertical sync signal may be the last post equalizing sync pulse on lines 5 and/or 317. So an embodiment of the invention may include adding pulses (e.g., negative going pulses, pseudo sync pulses or pulse pair signals) on lines 6, 7, 318, and or 319. Similarly, in a 525 TV line standard (FIG. 1C), pulses may be added, as described above, on lines 10, 11, 272, and or 273.

In another example, such as in a PAL standard, as long as there is no more than one video line after the vertical sync signal that is free of (extra) negative going (e.g., pseudo sync, or an extra sync) pulse(s), certain circumvention devices will be defeated by the new copy protection signal. Thus, an embodiment includes a number of lines containing negative going pulse(s) immediately after, or one line delayed from, a post equalizing vertical sync pulse (or a vertical sync signal). This number of lines may be consecutive in terms of containing negative going pulses, such as pseudo sync pulses, or may have one line in a set or series of TV lines that does not have the (e.g., extra) negative going pulses.

In one embodiment, typically 6-14 lines in the VBI (and or its vicinity) including 2-8 pseudo sync pulses or pulse pair signals (per line) will begin at lines 6, 7, 318, and or 319, for a 625 (PAL or. SECAM) line standard. Similarly, in a 525 NTSC or equivalent line locations for NTSC or PAL-M line standard the pulses begin at lines 10, 11, 272, and or 273.

FIG. 6C illustrates that there is no video line that is free of an extra negative going pulse(s) (e.g., no gap) because post equalizing pulses (e.g., line 5 part of a vertical sync signal) are followed in the next line with other negative going pulse(s) such as for example, pseudo sync pulse(s) on line 6 (in FIG. 6A). Thus, both timing circuits 22′ and 22″ fail to provide the correct blanking or removal pulse. Instead, the copy protection pulses of FIG. 6A are not removed or reduced, while blanking or removing occurs in a portion of the active video field. Modification or blanking of a portion of the video signal is denoted by the logic high states of signals 12* and or 12̂. In FIG. 6C, signal 12* shows how a circumvention device would remove or modify a portion of the signal from line 16 to a portion of the active field, while passing at least an effective number of copy protection signals residing prior to line 16. Similarly, signal 12″ shows again how a circumvention device would blank, attenuate, or modify a portion of the video signal from video line 17 to a top portion of the active video field, while allowing passage of copy protection signals prior to line 17.

It should be noted that the circuit 22 of FIG. 3A still effectively removes the new copy protection signal of FIG. 6A.

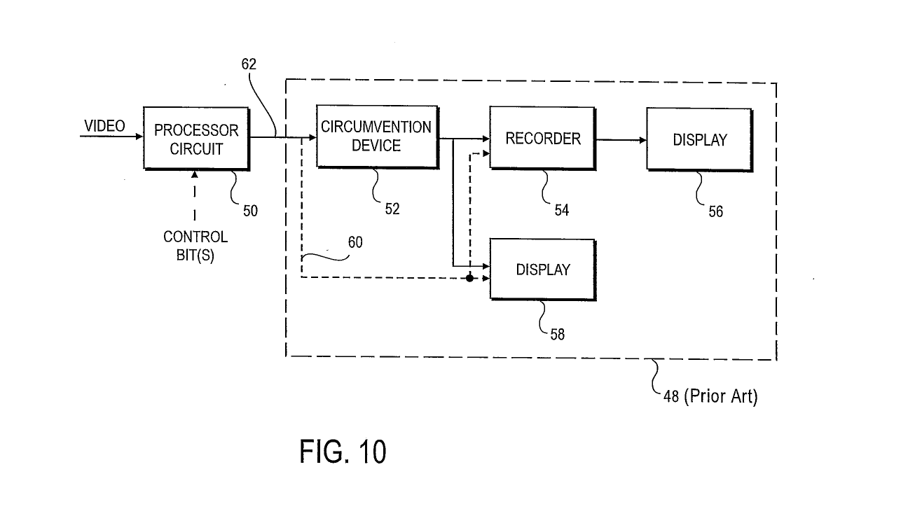

FIG. 7 illustrates a typical or standard video signal in a portion of the vertical blanking interval (VBI) and active television field. Color burst envelopes, which are used in recorder and or TV sets for proper color decoding or reproduction, are denoted by numeral 30. A Closed Caption (CC) data line or data signal is denoted by numeral 32. Active field (AF) program video (line) is illustrated by numeral 34.

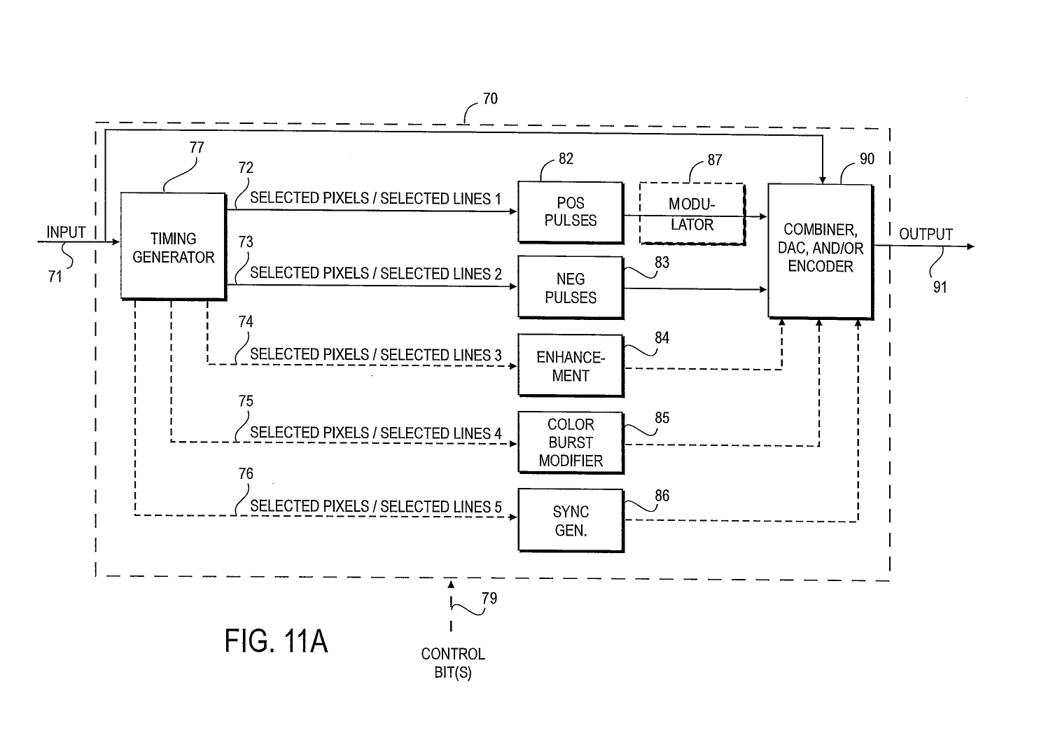

FIG. 8A illustrates a prior art copy protection signal including AGC pulses 36 and pseudo sync pulses 38.

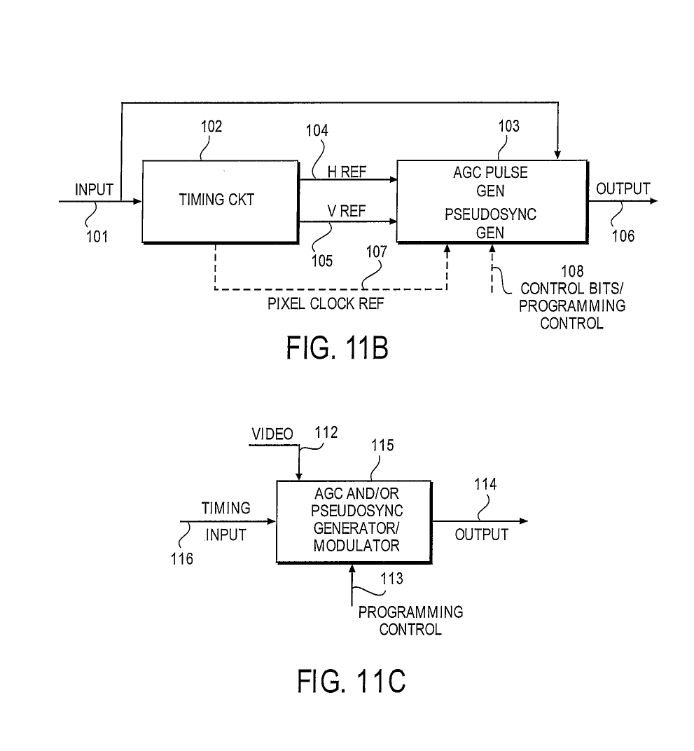

Just for illustration purposes, the number of pseudo sync and AGC pulses in FIGS. 8A, 9A and 9B, are shown to have 2 pulse pairs per TV lines, but any number greater than or equal to 1 pulse pair per line may be implemented in, for example, the FIGS. 8A, 9A, and or 9B.

FIG. 8B illustrates the effect of a circumvention device utilizing, for example, the timing circuit 22′ of FIG. 3B. The prior art copy protection signals 38 (pseudo sync) and 36 (AGC) shown in FIG. 8A, are removed, and so are a number of color bursts 30 of FIG. 8A removed in the VBI. The removal of color bursts is depicted in FIG. 8B by numeral 30′.

FIG. 9A illustrates an embodiment of a copy protection signal where the copy protection signals start sooner than the prior art copy protection signals; that is, start in the first or second line after the vertical sync signal. In FIG. 9A there is only a one line gap 40, which is free of copy protection (e.g., copy protection signal may include pseudo sync and or AGC) or “extra” negative going pulses (38′, or 38′ and 36′) after the vertical sync signal.

FIG. 9B then illustrates the effect(s) of a circumvention device mishandling the new copy protection signal (e.g., pseudo sync and or AGC pulses) shown in FIG. 9A. Here a microprocessor timing circuit 22′ (for example) causes the particular prior art circumvention device to pass one or more or all of the copy protections signals (e.g., pulses 38 and or 36) to the circumvention device's output, which action is opposite to the intended function thereof, thereby still providing the (black box's) output with an effective copy protection signal. Furthermore, the output of the prior art circumvention device includes the loss of the color bursts of FIG. 9A, into a top portion of the active field TV lines, which will cause noticeable and viewable color demodulation problems. The removal and thus lack of color bursts is depicted in FIG. 9B by numeral 30′.

Also, because a portion of the active video field is missing or blanked out, the effectiveness of the copy protection is enhanced. For example, signal 34′ denotes a blanked or altered portion of the active field video program signal 34 of FIG. 9A. For example, one or more or all of the copy protection signals is/are passed to the output of the circumvention device. But, the circumvention device also provides a blanked portion of viewable video, and/or provides loss of color burst, as depicted by numeral 30′(blanked or modified color burst) in FIG. 9B, in sufficient TV lines to cause errors in color demodulation or decoding in a TV set or recorder. So by providing or synthesizing the new copy protection signal, certain black boxes actually increase the effectiveness of the enhanced and or new copy protection signal. Alternatively, the certain circumvention devices cause playability problems on TV monitors as, for example, by blanking or modifying one or more color burst signals (e.g., FIG. 9B, numeral 30′).

Also shown in dotted lines in FIG. 9A or 9B, is an alternative new copy protection process where copy protection signals 36′, 38′ are added in the first video line interval after V sync, whereby there is no TV line free of copy protection or negative going pulses after a vertical sync signal. This alternative embodiment works similarly in that one or more or all copy protection signals are passed to the output of the circumvention device (e.g., circumvention devices that utilize for example, a microprocessor timing circuit 22′ (FIG. 3B) or a retriggerable timing circuit 22″ (FIG. 3C). The circumvention device further enhances the new copy protection process by blanking out a portion of an active field (as depicted by numeral 34′, FIG. 9B), and or causes improper locking of color reproduction on a TV monitor or recorder as, for example, by blanking or modifying one or more color burst signals (as depicted by numeral 30′). It should be noted for clarity in the illustrations for FIGS. 8A, 9A, and or 9B, one or more color burst envelope is not necessarily labeled as 30 on every line.

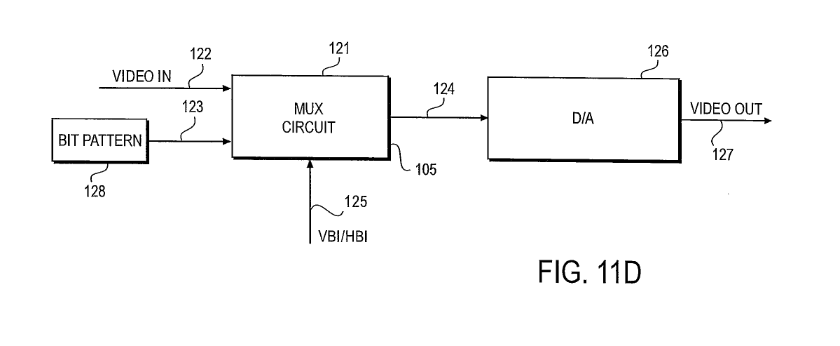

FIG. 10 illustrates an example of an embodiment of the invention, comprising a processor circuit 50. Circuit 50 may be part of an integrated circuit, which receives video in analog and or digital form. Circuit 50 outputs an analog video signal that provides a copy protection effect and reduces the effectiveness of a circumvention device. To this end, the apparatus may include control bit(s) to configure (any of the) various versions of the waveforms (e.g. FIGS. 2A, 2B, 5A, 6A, and or 9A) and or to enable or to disable any version of the copy protection signal at the analog output of processor circuit 50. For example, digital video may be coupled to an input of processor circuit 50, which may include one or more waveform circuits (e.g., fixed or programmable) to synthesize one or more negative going pulse, or one or more pulse pair signal including sync/pseudo sync and AGC pulse. The negative going pulse(s) are included immediately following, or in the next line after, a vertical sync signal, or a first/second line after a vertical sync signal that is typically outside a sync interval or location. Circuit 50 may include an encoder and or digital to analog converter to provide an analog signal of one or more TV standards. The analog signal may include a copy protection signal that is resistant to black boxes, a copy protection signal that causes a black box to further discourage copying and or to cause the black box in conjunction with the copy protection signal to provide a synergistic copy protection effect.

A synergistic effect may include passing one or more copy protection signals or pulses to the output of the circumvention device, which causes darkening or other copy protection effects on a recording, while causing the circumvention device to implement one or more of the following artifacts:

1) A clamp error in a portion of the program video signal, which causes level shifting, typically undesirable, in a part of the video signal.

2) A loss of color burst in one or more active TV lines.

3) A loss of program video information in one or more active TV line, which can include darkening or a blanking near or at the top of the display (or from a recorder).

4) Color unlocking or color distortion (e.g., errors in hue and or saturation) in one or more active TV lines, which can lead to incorrect color displayed on one or more lines near or at the top of the display, or loss of color for one or more lines near the top of the display. Recorders may also exhibit extra color unlocking (or color distortion) upon record and or playback.

5) New or increased playability artifact(s) when coupled to a TV display, which can include both (or either) color and extra darkening (or blanking and or attenuating) effects on a TV display and or a recorder.

Processor circuit 50 may include control bits or one or more bit patterns to enable, configure, and or disable at least a portion of the copy protection signal.

Also illustrated in FIG. 10 is an exemplary prior art circumvention device (“black box”) 52 (e.g., a circumvention device with a timing circuit 22′ or 22″), a recorder 54 coupled to the prior art circumvention device 52, and a first display 56 that is coupled to the recorder. Also shown is a second display 58 coupled to an output of circumvention device 52.

Dashed line 60 depicts a “bypass” mode where the new copy protection signal is coupled directly to recorder 54 and display 58. In this bypass mode, the new copy protection signal has little or no artifacts displayed on display 58. In the bypass mode, recorder 54 and a playback monitor show a darkened playback of an illegal copy, or other copy protection effects such as, for example, AGC gain variation or effect, brightness change, and or turning off (for a compliant device) the recording/viewing process.

However, if the bypass mode is not used, the circumvention device's input 62 is coupled to a video source (via processor circuit 50) with the new copy protection signal(s).

The output of circumvention device 52 then outputs a video signal with a copy protection signal, which in turn causes recorder 54 to exhibit copy protection effect(s) such as darkening, AGC effect, brightness change, and or shutting down (e.g., compliant device will shut down recording or viewing), and one or more of the following problems:

A clamp error in a portion of the program video signal.

A loss of color burst in one or more active TV lines.

A loss of program video information in one or more active TV lines.

A color unlocking or color distortion in one or more active TV lines.

A new or increased playability artifact(s) when coupled to a TV display.

It follows that inserting a circumvention device actually causes more video problems than without it when the new copy protection signal is applied. That is, the new copy protection signal causes more problems for a video pirate than without the circumvention device. For example, as previously explained, the new copy protection signal causes the circumvention device to enhance the copy protection effect, thereby discouraging the making of illegal copies of video programs.

Accordingly, it is noted that one or more of the new copy protection processes provide resistance to circumvention device(s) (black boxes) or provide enhancement of or synergy to the copy protection process (or effectiveness).

It should be reiterated that the new copy protection signal embodiments also reduce playability problems in some monitors. For example, by shifting the copy protection signals toward the vertical sync signal, an overshoot or ringing error in the TV set's phase lock loop feedback system settles down better by the time an active field is displayed.

This better settling time in the horizontal scanning circuits of a TV set is especially applicable to copy protection signals where there is a position and or pulse-width modulation in the pseudo sync or AGC pulses from one TV line to another, or where the number of pseudo sync or AGC pulses changes from one TV line to another.

Correspondingly, a better settling time in a horizontal display or scanning system provides improved playability of the copy protection signal.

Thus, a prior art waveform (e.g., for PAL or NTSC) that is shifted or moved (e.g., advanced) toward the vertical sync signal, provides better playability. For example, copy protection signals, such as pseudo sync and or AGC pulses that are provided further away from the active field provide less noticeable hooking or tearing at the top of a display screen or in a portion of the overscan area.

For example, one 625 line standard, prior art copy protection signal, has a Format A that has seven pulse pairs (pseudo sync/AGC) on line 8 (and or lines 10, 12, 14, 16), which is then followed by Format B that has six pulse pairs on line 9 (and or lines 11, 13, 15). An example of Format A is 1.63 microseconds (+/−100 ns) wide for pseudo sync and 7 pseudo sync pulses per line, and or Format B is 1.78 microseconds (+/−100 ns) for pseudo sync and 6 pseudo sync pulses per line, or vice versa. Other numbers or values can be provided. This prior art signal then does not have resistance to certain black boxes and or can be improved in playability.

Thus to provide resistance to or defeat of a circumvention or black box device and or to provide improved playability, one or more embodiments include(s) shifting either (or both) formats A and/or B one or two lines toward the vertical sync signal such as:

1) Format A starting on line 6 (or 318) and/or line 7 (or 319)

2) Format B starting on line 6 (or 318) and/or line 7 (or 319)

Other alternative embodiments include:

Adding/inserting/synthesizing a Format A or Format B copy protection signal (e.g., starting) on lines 6, 7 and/or 8 and/or lines 318 and/or 319. In one example for a 625 line standard system, lines 6, 8, 10, 12, and or 14 (and/or 16) may be of Format A (or B), while lines 7, 9, 11, 13, and or 15 may be of Format B (or A). Format A represents a set of pseudo sync and or AGC pulses and Format B represents another set of pseudo sync and or AGC pulses.

Note that in general, any type of Format A and/or Format B signals may be provided in one or more selected TV lines, provided with a selected number of pulses (e.g., pseudo sync and or AGC) per line, or provided with selected pulse-width, pulse amplitude, and/or pulse position, for any of the added pulses (or sync pulse(s)). In certain cases Format A equals Format B, for example, for two or more consecutive lines. A copy protection process including two or more consecutive lines of (substantially) the same format toward the active field is one embodiment to improve playability or to still cause a problem with circumvention devices. For example, a process can start right after or delayed less than 2.5 lines after the vertical sync signal, with two formats interweaving/interlacing from one line to another. However, the last two or more lines that include pseudo syncs or copy protection signals may be a single format. Also, there is no limitation on how many formats can be provided (e.g., one or more formats).

One example (e.g., for improved playability) provides/includes one or more (e.g., 4, 5, 6, or 7) pseudo sync or pseudo sync AGC pulses in three or more TV lines with at least one series of alternating formats in two (or more) lines (e.g., in consecutive lines), while providing two consecutive lines with substantially the same format. For example, a series of TV lines may include A′A′B′, B′A′A′, A′B′A′B′B′, A′A′B′A′B′, etc., where A′ and B′ each denote a particular format. In general, each format includes a particular number of pseudo sync and or AGC pulses per line, and or includes pseudo sync and or AGC pulse width and or position. U.S. Pat. No. 6,836,549 by Quan and Brill issued on Dec. 28, 2004, incorporated by reference, describes various methods and apparatuses for modulating in position, pulse width, and or amplitude of sync/pseudo sync and or AGC pulses, or changing the number of copy protection signals from one line to another, or gap-width modulation. Any example may include one or more of the various methods or apparatuses as described above for U.S. Pat. No. 6,836,549.

In any of the processes/embodiments mentioned (e.g., copy protection signals that provide resistance to circumvention and or improved playability), one or more of the following may be provided/generated/inserted/added to illustrate a further method and or apparatus combination.

1) Modulating any of the copy protection pulses such as, for example, pseudo sync and or AGC pulses, by amplitude (e.g., may include a finite value and or zero amplitude), pulse-width, position, and or frequency (e.g., including changing a number of negative or positive going pulses from one video line to another line). Or providing at least one number (e.g., two or more different numbers) of pseudo sync and or AGC pulses per TV line interval in selected (e.g., two or more) TV lines.

2) Changing or shifting a portion of a video signal from one video line to another line such as, for example, lowering or raising a blanking or black level from one line to another line or from one set of lines to another set of lines. U.S. Pat. No. 5,583,936 by Wonfor et al. issued Dec. 10, 1996 and its divisional and continuation patents, incorporated by reference, describe modifying a basic copy protection signal (e.g., AGC pulses and or pseudo sync/AGC pulses) with level shifting a portion of the video signal, including a portion of the active video signal and or a portion of one or more blanking intervals, for example, a portion of front and or back porch region.

3) Adding or providing a color burst modification of at least a portion of one or more color burst envelopes. The modification may include phase, frequency, and or amplitude of one or more cycles of subcarrier, or may include adding cycles of subcarrier (e.g., widened (modified or unmodified) color burst envelope) or a reduced duration color burst envelope (modified or unmodified). One or more color burst modification is shown in U.S. Pat. No. 6,516, 132 by Wrobleski and Quan issued Feb. 4, 2003, incorporated by reference, and/or U.S. Pat. No. 7,039,294 by Quan issued May 2, 2006, (incorporated by reference. An example comprises segmentation of one or more color burst envelopes with two or more phases (e.g., normal and non-normal phase), and/or addition of extra cycles of subcarrier in one or more horizontal blanking intervals, which can provide an extended (modified) color burst. Also sync position and or width may be altered.

4) Combining content control or copy protection signal(s) (e.g., back porch pulses, AGC pulses, data, CGMS, flag signal, and or pseudo sync pulses) with other TV standards such as progressive (e.g., 240 p, 480 p, and or 576 p), HDTV, and or low definition TV. Flag signals, data signals, and or copy protection signals for detection or use in a content control device/system is described in U.S. Pat. No. 5,315,448 by Ryan, issued May 24, 1994 and incorporated by reference.

5) Providing dynamic blanking or modification of a video signal (e.g., one or more active field video line or one or more color burst in an active field) via coupling to a circumvention device by changing or modifying/modulating negative going pulses in a portion of the vertical blanking interval. For example, if negative going pulses near the vertical sync signal are provided or removed (or changed in position, amplitude, or width) as a function of time, the circumvention device will blank a portion of active (field) video lines (and or pass through one or more copy protection signal) when the negative pulses are provided, and then not blank a portion of active (field) video lines (while reducing an effect of the copy protection signal(s)) when the negative pulses are not provided. An illustration of providing a dynamic copy protection signal or effect via a circumvention device would be to alternate/switch in time prior art signals of FIG. 1A or 1B and signals of FIG. 2A or 2B. The output of the circumvention device will then generate a newly provided amplitude modulated (effect) of copy protection signals by modulating (in one to three lines) negative going pulses after a vertical sync signal.

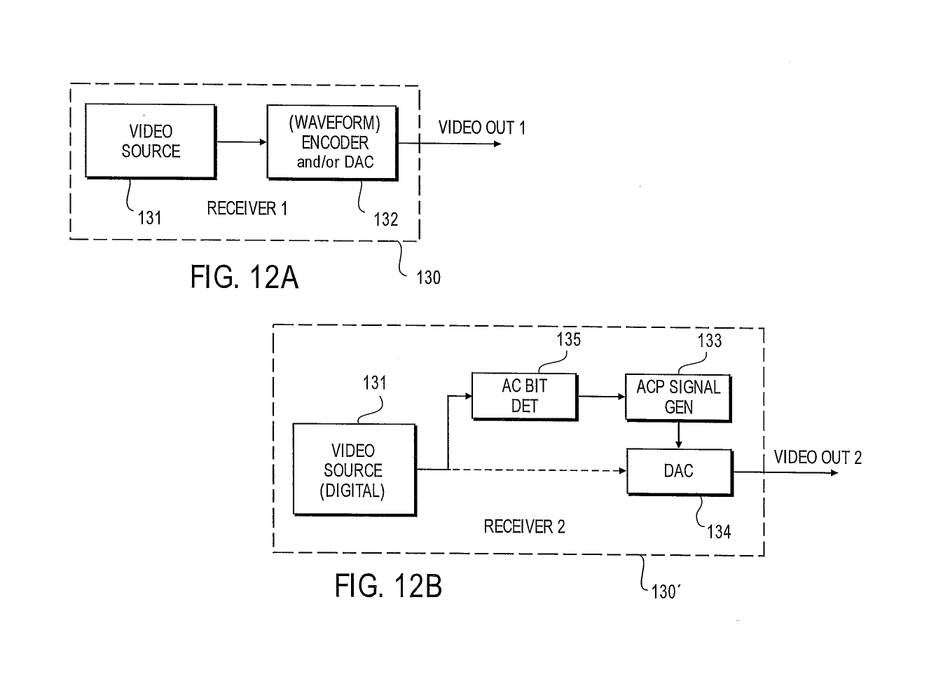

FIGS. 11A through 11D illustrate example apparatuses or systems for implementing in combination with receiving devices the various waveforms of description herein, in accordance with the invention.

In FIG. 11A, video (analog or digital) is supplied or coupled to an input 71. A timing generator circuit 77 receives the video signal via input 71, and produces one or more various timing signals for selected pixels/selected video lines such as provided on leads 72, 73, 74, 75, and or 76.

For example, lead 72 produces a timing signal for providing positive going pulses such as AGC pulses in selected video (TV) lines and selected pixels. The timing signal on lead 72, for instance (in the VBI) can provide a logic high signal for selected pixels on (any combination of) TV lines 317 (or 6), 318 (or 7), and or up to 327 (16) for a 625 line TV standard system, which when coupled to a positive pulse generator 82, provides AGC or positive going pulses to a video output 91 of a combiner, DAC and or encoder circuit 90. Similarly, for a 525 TV line standard system, the video line allocation may include any combination of video lines from 10-20 and/or 272- 283. Any of the positive going (e.g., AGC) pulses may be modulated in position, amplitude, and or pulse-width (e.g., within an interval or from one TV line to another) via an optional modulator circuit 87 (shown in dashed line).

For the positive going pulses, lead 72 may include providing an AGC or positive going pulse in a portion of the back porch, or a portion of a horizontal blanking interval, of selected TV lines (e.g., providing back porch pulses). For example, the selected lines may include one or more TV lines in an overscan area, such as a bottom of the TV field, a portion of the VBI, and or a top of the TV, field. These back porch pulses may be modulated in position, amplitude, and or pulse-width from one TV line to another via the optional modulator circuit 87. Also, amplitude modulation may be applied to one or more of the back porch pulses.

A signal for selected TV lines and pixels, for providing negative going pulses for one or more embodiments, is supplied on a signal lead 73 that is coupled to a negative pulse generator 83. Generally, in the VBI, the negative going pulses may include the allocation of TV lines mentioned for signal lead 72 above. It should be noted that signal leads 72 and or 73 (via setting the selected pixels) can provide a different number of pulses, positive and or negative going pulses, a position change, and or a pulse-width change. For example, the signals can provide position modulation and or pulse width modulation of pseudo sync and or AGC pulses, from one TV line to another (e.g., in the VBI) for a video output such as on output terminal/connection 91.

Other features may be included in the negative going pulses or pseudo sync pulses that provide a copy protection signal resistant to certain black boxes. For example, an enhancement signal may be added. To this end, a selected line and or pixel signal lead 74, may provide an enhancement circuit 84 with an increased or modified copy protection effect via the circuit 90 and output 91. In one example, signal lead 74 provides selected lines and pixels to lower or to level shift (e.g., level shift up or down) at least a portion of the active video signal, and or level shift at least a portion of the front and or back porch region. For example, by level shifting down a portion of one or more TV line(s) lower than a black level or a blanking level compared to another portion of the TV signal, the copy protection effect or copy protection signal is modified or enhanced. In one (enhancement) example, one or more portions of one or more active field line(s) is shifted or lowered in black or blanking level compared to the blanking or black level of one or more TV lines in a portion of the VBI.

Another signal modification that may be included with the one or more embodiments mentioned, that provide content control or copy protection and or resistance to certain black boxes, is the color burst phase or amplitude modification for selected TV lines. This color burst modification may include segmentation of phases and or amplitudes for providing a modified color burst in one or more horizontal blanking interval(s). Thus, the timing generator 77 provides a signal on signal lead 75 that allows selected lines and pixels to be modified such that a modified color burst is synthesized via a color burst modifier circuit 85 and combiner, DAC and or encoder circuit 90. Circuit 85 receives a signal on lead 75 to generate a modified color burst for selected lines and portion of the horizontal blanking interval (HBI). The output of circuit 85 may include an analog signal or digital signal.

For example, if the input 71 is analog, the output of circuit 85 may include a color subcarrier generator, which provides a PAL or NTSC modified color burst on selected TV lines and generally normal color burst on another set of TV lines. Should input 71 include a digital signal, circuit 85 may output digital signals to a digital color (subcarrier) encoder (not shown) such as one that would be included in circuit 90, to provide a color burst signal at output 91 that is modified for one set of TV lines and substantially normal color burst on another set of TV lines. The digital color (subcarrier) encoder may provide component video signals (e.g., R-Y, B-Y, I, or Q signals), which are modified in selected TV lines and pixels (e.g., in an HBI portion) to a color subcarrier encoder. The encoder encodes a modified PAL and or NTSC color burst signal such as, for example, color stripe, split burst color stripe, segmented phase/amplitude color burst signal, widened or narrowed color burst or color stripe envelope, and or advanced or delayed color burst or color stripe signal.

Yet another signal modification that may be included with the one or more embodiments mentioned, that provides content control or copy protection and or resistance to certain black boxes, is sync amplitude, position, pulse width or level shift modification for selected TV lines. A signal lead 76 provides a logic signal for selected lines and pixels to generate sync pulses of selected amplitude, position, level shifting, and or pulse-width via a sync generator circuit 86. In some instances, the copy protection or copy protection effect may be increased in effectiveness or modified via sync amplitude reduction and or sync width reduction on one or more TV lines. The output of circuit 86 is then coupled to the circuit 90 to provide a TV signal with one or more modified horizontal and or vertical sync pulse/signal.

Shown in dotted lines in the system 70, is (optionally) an input of one or more control bit(s) or bit pattern on a lead 79 that allows turning the system on or off. For example, the input on lead 79 may provide one or more waveforms such as a negative going pulse, a positive going pulse, an enhancement or modification signal (level shifting one or more portions of a video signal), color burst modification, and or sync modification, or may provide configuring/enabling/disabling the negative and or positive going pulses, or may configure/program/enable/disable an enhancement signal, color burst signal, and or sync signals.

FIG. 11B illustrates another apparatus, which receives an analog or digital signal at input 101. The input 101 is coupled to a timing circuit 102, which outputs horizontal and vertical reference signals 104 and 105 respectively. These reference signals 104 and 105 are then coupled to a pseudo sync pulse generator and AGC pulse generator circuit 103. The timing circuit 102 may also provide a pixel clock reference 107 to the circuit 103. The reference timing signals and also the input signal are coupled to circuit 103 which then provides a video signal with pseudo sync pulses and or AGC pulses at an output 106 that causes certain black boxes to pass at least some of the pseudo sync or pseudo sync and AGC pulses. By causing the black box to pass at least some of the copy protection pulses, an effective copy protection or content control signal is provided at the output of the certain black boxes, which is contrary to the design goal or intent of the black box or circumvention device. Circuit 103 may include control or programming from one or more control or programming signals or bit(s) or bit pattern(s) as depicted at an input 108. For example, in response to a control signal, control bit, or bit pattern 108, the line location, pulse width, pulse position, and or amplitude of pseudo sync and or AGC pulses may be set as by one or more bit pattern(s). A control signal or control bit may enable/disable and or program any of the waveforms and or any other waveform (e.g., enhancement signal, color burst modification, sync modification, etc.) that may be combined with, for example, a receiving device in accordance with the invention.

FIG. 11C illustrates a processor (circuit) 115 supplied with an input video signal on line 112 (analog or digital) and a timing signal on a line 116. Processor 115 includes a generator and or modulator. The modulator may modulate pulse width, pulse position, gap width such as between a negative going pulse and a positive going pulse, and or may modulate the amplitude of AGC pulses and or sync/pseudo sync pulses. For example, with the pseudo sync/AGC line locations of previous description, that cause a black box to become ineffective, the pseudo sync and or AGC pulses may be position or pulse width modulated within a video line or from one video line to another. The copy protection pulses such as AGC pulses may include amplitude modulation. An example output of processor 115 is a signal on output 114, which may include a static or dynamically modulated copy protection waveform(s), which defeats or reduces one or more effects of a black box, provides resistance to certain black boxes and or which improves on playability. Processor 115 may (also) include an enabling, disabling, and or programmability (control) bit or signal on an input 113 such as previously mentioned for example in FIG. 11A and or FIG. 11B.

FIG. 11D illustrates an apparatus for use in the digital domain. A digital video signal is coupled to an input 122 of a switching or multiplex (MUX) circuit 121. Another input 123 supplies a bit pattern signal from a bit pattern generator 128, which provides digital words or bytes (or a bit pattern) that switch in various levels to provide negative going and or positive going pulses at an output 127 of a digital to analog converter 126. The circuit 121 also is supplied with a switch or multiplex control signal on an input 125, which is enabled during one or more portions of the VBI and or HBI. For example, during a portion of the VBI, such as immediately after (or up to one line delayed after) a vertical sync signal or equalizing pulse, the bit pattern generator 128 is switched in by the control input 125. Generator/source 128 provides a digital signal such that when circuit 121 is coupled to the digital to analog converter (D/A) 126, pseudo sync and or AGC pulses are provided to the video signal on input 122 with one or more pseudo sync pulses and or AGC pulses from zero to about 1.5 TV line(s) after a post equalizing pulse or after a vertical sync signal, wherein the vertical sync signal includes pre-equalizing syncs, broad sync pulses, and post equalizing syncs. When a portion of the HBI is enabled or turned active, generator 128 can provide a bit pattern which provides an AGC pulse (and/or negative going pulse) in a portion of the back porch or HBI of selected TV lines on the video output 127.

A summary of the copy protection signals and the circuitry of previous description is as follows:

1) A method of providing a video copy protection signal to a video signal to form a copy protected video signal which causes a circumvention device to pass at least some of the video copy protection signal at the output of the circumvention device. The method includes inserting or adding, in at least one TV line, one or more pseudo sync pulses, or one or more pseudo sync pulse/AGC pulse pair signals immediately after a vertical sync signal, or delayed one line or delayed less than 2 or 2.5 lines after a vertical sync signal or post equalizing pulse. It follows that the copy protected video signal is substantially effective in providing copy protection or content control after passing through the circumvention device, contrary to the intended function of the circumvention device.

2) Wherein at least one TV line with one or more pseudo sync pulse and or AGC pulse, includes up to 18 TV lines including one or more pseudo sync pulse and or AGC pulse per TV line, or wherein the number of pseudo sync and or AGC pulses changes from one TV line to another TV line.

3) Wherein the copy protected video signal is a composite, component, PAL, NTSC or SECAM copy protected video signal, or wherein horizontal sync(s), pseudo sync(s), and or AGC signal(s) are position, pulse-width, and or amplitude modulated from one TV line to another TV line, or within a TV line .

4) Wherein the circumvention device adds or enhances copy protection effectiveness after processing the copy protected signal.

5) Wherein the circumvention device further blanks a portion of the active video field.

6) Wherein the circumvention device further blanks out color burst signals in one or more TV lines in the active TV field.

7) Wherein one or more TV lines in the active TV field exhibit color distortion via the circumvention device.

8) Wherein the copy protected signal includes improved playability over a copy protected video signal which inserts pseudo sync pulses two or more lines after the vertical sync signal.

9) An apparatus for providing a video copy protection signal to a video signal to form a copy protected video signal which causes a circumvention device to pass at least some of the video copy protection signal at the output of the circumvention device. The apparatus includes a processing circuit receiving a video signal, for inserting or adding one or more pseudo sync pulses or pseudo sync/AGC pulse pair signals in at least one TV line immediately after, or one line or less than 2 or 2.5 lines after, a vertical sync signal or post equalizing pulse, to provide the copy protected video signal.

As mentioned previously, the invention involves providing a copy protection signal in combination with a receiver, and including pseudo sync and AGC pulses for a pulse pair signal, wherein a location of the pseudo sync pulses provides resistance to a circumvention device, wherein the circumvention device passes at least one pulse pair signal, and wherein the location of pseudo sync signals start immediately after or less than 2 or 2.5 lines after a vertical sync signal or post equalizing pulse. The combination includes one or more of the following: a color burst modification of whole or segmented sections of one or more color burst envelope which includes one or more cycles of incorrect color burst, level shifting a portion of the video signal including lowering or raising one or more portions of the video signal, modifying sync location, amplitude, and or pulse width at selected TV lines, providing back porch pulses of different video levels from one TV line to another, providing pseudo sync and or AGC pulses of different pulse widths from one TV line to another, providing pseudo sync and or AGC pulses of different numbers from one TV line to another.

Thus, a receiver in combination with the copy protection signals of previous description, causes a circumvention device to modify the video signal so as to increase copy protection effectiveness while passing at least part of the copy protection signal to maintain copy protection effectiveness from the copy protection signal. The increased effectiveness provided by the circumvention device includes modifying one or more color burst signals to cause new color distortion, and or blanking/modifying a portion of the visible view area, by starting the copy protection signals immediately after or less than 2 or 2.5 lines after a vertical sync signal or post equalizing pulse.

In terms of chroma effects, an embodiment includes increasing color copy protection effects of a copy protection signal provided by a circumvention device, wherein the copy protection signal includes color burst modification in selected TV lines, and wherein the color burst modification causes a recorder or TV set to produce color distortion. This process includes combining pseudo sync and or pseudo sync and or AGC pulses immediately after or less than 2 or 2.5 lines after a vertical sync signal or post equalizing pulse with the color burst modification. The color burst modification includes cycles of incorrect phase or frequency in selected TV lines, wherein the circumvention device outputs a copy protection signal which produces color distortions of the modified color burst in the copy protection signal and extra color distortion due to blanking or modifying color burst envelopes in an active field caused by the circumvention device. For example, the circumvention device senses the pseudo sync signals to cause incorrect blanking or modification of the copy protection signal, which may include passing some or all of the pseudo sync and or AGC signals to the output of the circumvention device.

Circuitry for any of the above embodiments, methods, and or apparatuses may be included in an integrated circuit or part of an integrated circuit. Media players, tuners, receivers, optical storage players or recorders, hard drive or magnetic storage players or recorders, solid state memory recorders or players, receivers, recorders, cell phones, TV sets, etc. may include the integrated circuit or circuitry to provide at least a part of any of the waveforms or embodiments of previous description herein. Such waveforms or embodiments, when utilized in a receiver in accordance with the present invention, provide resistance to certain circumvention devices and or improve signal playability. For example, playability is improved over prior art copy protection signals in terms of less hooking or via less scanning error in a TV display.

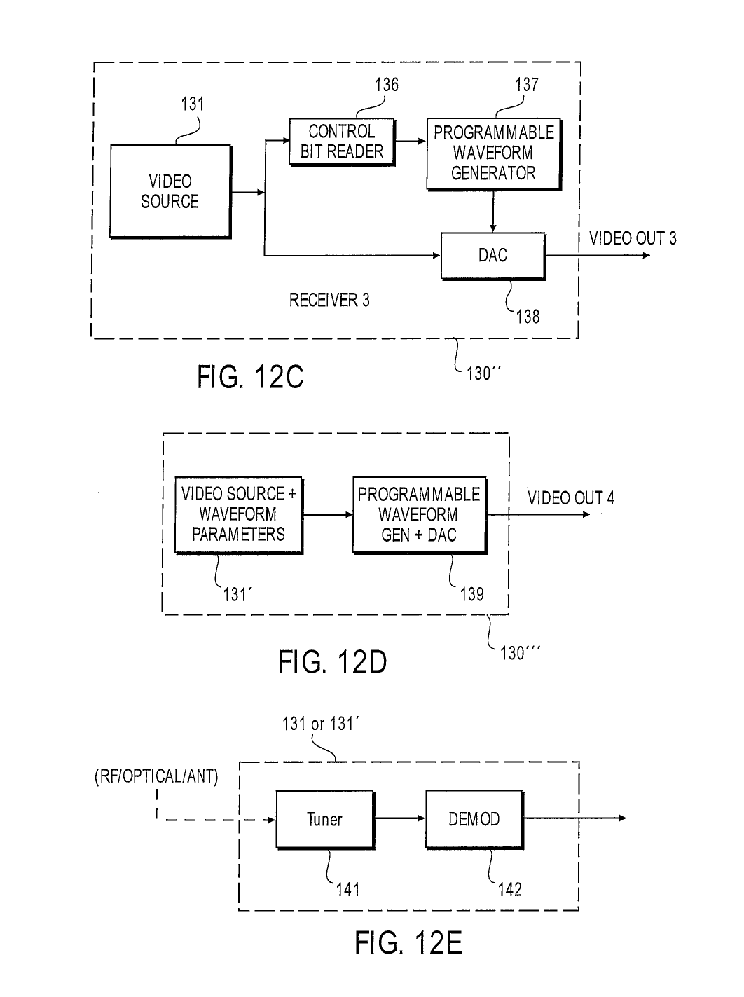

To this end, FIG. 12A illustrates an embodiment of the invention comprising a receiver 130 with a video source 131, and including an encoding and or digital to analog converter (DAC) 132. A receiver may include a set top box, TV set, mobile TV device, cell phone, and or the like. The receiver 130 provides a video output with one or more of the waveforms (Le., the copy protection signals) previously described herein which provide resistance to a circumvention device, provide enhanced copy protection, or provide improved playability in a copy protected video signal. The video source 131 may be a video programming or program from a digital delivery network, Internet, LAN, WiFi, wireless, WiMax, and or a system opertator. The video source may provide a digital video signal, RF (video) signal, and or an analog video signal. The encoder and or DAC 132 is coupled to the video source 131 and typically provides an analog video signal (Video out 1) with one or more of the waveforms previously mentioned, to provide a copy protected video signal. This copy protected video signal may be “on” by default (e.g., any of the inventive copy protection signals can be provided to the output of the media player upon applying power) or turned on by one or more control bits within the video source 131 or from internal or external signal(s).

Control bit(s) may select one or more waveforms or video signal modifications for the Video out 1. For instance, in the field 2 of a 525 line system, one or more pseudo sync pulse may be inserted or added in video line 9 (e.g., FIGS. 12A, 12B, 12C, and or 12D) to cause a circumvention device to pass the copy protection signals to the output thereof and or to cause the circumvention device to attenuate (and or level shift) a number (e.g., >=1) of active or viewable video line(s), to provide an enhanced copy protection effect.

FIG. 12B illustrates a receiver 130′ of the invention that includes a copy protection bit detector, such as an AC bit detector 135. Here the AC (anticopy) bit detector 135 reads or senses a digital bit stream from the video source 131. For example, upon sensing one or more bit(s), the output of video source 131 sends a command or signal via the bit detector 135 to a copy protection signal generator 133 to provide one or more signals, or video signal modifications as previously mentioned, to a DAC (digital to analog converter) 134. The DAC 134 outputs a copy protected video signal (Video out 2), which provides resistance to a circumvention device, enhances a copy protection effect via the circumvention device, and or provides improved playability of the copy protected video signal. Note that DAC 134 may be coupled to the video source 131, as depicted in dashed line.

FIG. 12C illustrates an expanded example 130″ of the receiver of FIG. 12B, in accordance with the invention. Here a more flexible programmability of the copy protected video signal is provided. The video source 131 is coupled to a control bit(s) reader/sensing circuit 136, which provides typically one or more signals to program various parameters of the copy protected video signal. The circuit 136 is coupled to a programmable waveform generator 137 which provides the flexibility to program one or more copy protected video signals. The output of generator 137 is coupled to an encoding and or DAC 138. Also the DAC 138 may be coupled to the video source (e.g., playback mechanism or media reader). The output of DAC 138 (Video out 3) then provides a copy protected waveform with programmability to provide resistance to a circumvention device, enhance a copy protected video signal via the circumvention device, and or provide improved playability of the copy protected video signal.

Programmability for example via the waveform generator 137 may include using a bit pattern or one or more APS bits to implement a Type-n signal. For instance, a Type 1 signal may include pseudo sync pulses in selected TV lines that cause a circumvention device to fail fully or partially. Alternatively, a type 1 signal may cause a circumvention device to further enhance a copy protected signal by altering portions of the video signal, such as by attenuating, blanking, and or level shifting TV line(s) associated with an active field. A Type 1 signal may include sync reduction in selected TV lines, lowered front porch level in selected lines, and or lower back porch level in selected lines. In terms of modification to pixels or portions of the active line, an embodiment of the invention may include a setup level (e.g., 7.5 IRE in a 525 line system) or pedestal in the range of 1-25 IRE for one set of TV lines , and another set of TV lines (e.g., at least one line prior to a vertical sync signal or pre equalizing pulse) that does not include a set up level or pedestal (e.g., around blanking level or below blanking level).

A Type 2 (copy protected video) signal may include a Type 1 signal with a first type of color burst modification (e.g., partial, full or split burst color stripe signal). Or a Type 3 signal may include a second type of color burst modification signal along with a Type 1 signal.

Programmability, for example, via the waveform generator 137, may include line assignment of the pseudo sync pulses, number of pseudo sync pulses per line, position of pseudo sync pulses, and or width of pseudo sync pulses. Programmability may include a negative or positive voltage level to be assigned selected lines for front and or back porch region(s). U.S. Pat. Nos. 5,583,936 ('936) and 7,050,698 ('698) relate to adding or inserting a lowering signal in the front and or back porch area. Both patents are incorporated by reference.

Lowering and or raising levels in one or more selected portion of the video signal outside a horizontal blanking interval may be part of a programming capability (e.g., of a waveform generator or biasing circuit). For example, a portion (blanking level, front or back porch) of the VBI (vertical blanking interval) may be raised or lowered with respect of one or more lines outside the VBI. (or vice versa).

For a color burst modification, programmability may include line assignment for the modified color burst and or unmodified color burst, phase angle, zone(s) of correct or incorrect phase, and or duration of one or more zones. Such variation of a color burst is disclosed in U.S. Pat. No. 6,516,132 ('132) and or 7,039,294 ('294). Both of these patents are incorporated by reference.

FIG. 12D illustrates another embodiment of the invention, a receiving device 130′″ of the invention. Here, a video source 131′ is coupled to a programmable waveform generator and DAC 139, and includes information (bit or bits) which allows programming the copy protected waveform. The video source 131′ thus may include solid state, optical, and or magnetic memory, which contain programming information (or actual waveform(s)) for instance to provide flexible implementation of the copy protected waveform, which can change from one recorded media version to another. For example, not only will the copy protected waveforms from the programmable waveform generator/DAC 139 provide resistance to circumvention devices, enhance copy protection, and or improve playability, the copy protected waveform(s) may be updated to a new waveform to further improve effectiveness of a VCR and or circumvention device, or to provide further improved playability. U.S. patent applications Ser. Nos. 10/968,487 and 11/228,757 describe examples of programmability of copy protection signals from the media or external sources. For example, for a media player and or receiver, updating its copy protection signal(s), and or modification to the video signal, is provided via any combination of media, memory device, storage device, Internet, digital network, computer, etc. Both applications are incorporated by reference.

FIG. 12E illustrates an example embodiment of the invention. Here a video source or part of a receiver has a signal source such as an antenna, RF source, and or optical link that is coupled to an input of tuner 141. The output of the tuner 141 is coupled to a demodulator (DEMOD) 142. Typical demodulators 142 may include a circuit for I and or Q demodulation, phase demodulation, amplitude demodulation, frequency demodulation, and or pulse code demodulation. The block 131 or 131′ may include a decompression system for MPEG-x, H.26x, advance video coding (AVC), wavelet, DCT, DFT, motion JPEG, motion GIF, and or the like. The output of demodulator 142 is typically a digital video signal (but may include an analog video output).

In any of the receiving device examples of FIGS. 12A-12E, changes to the copy protection waveform may be implemented by an internal or external signal source, such as a link to a transmission site or a “smart card,” memory circuit or similar device.

U.S. Pat. Nos. 6,381,747 and 7,395,545, which describe a receiving system pertaining to providing signal modifications for copy protection or content control are incorporated by reference.

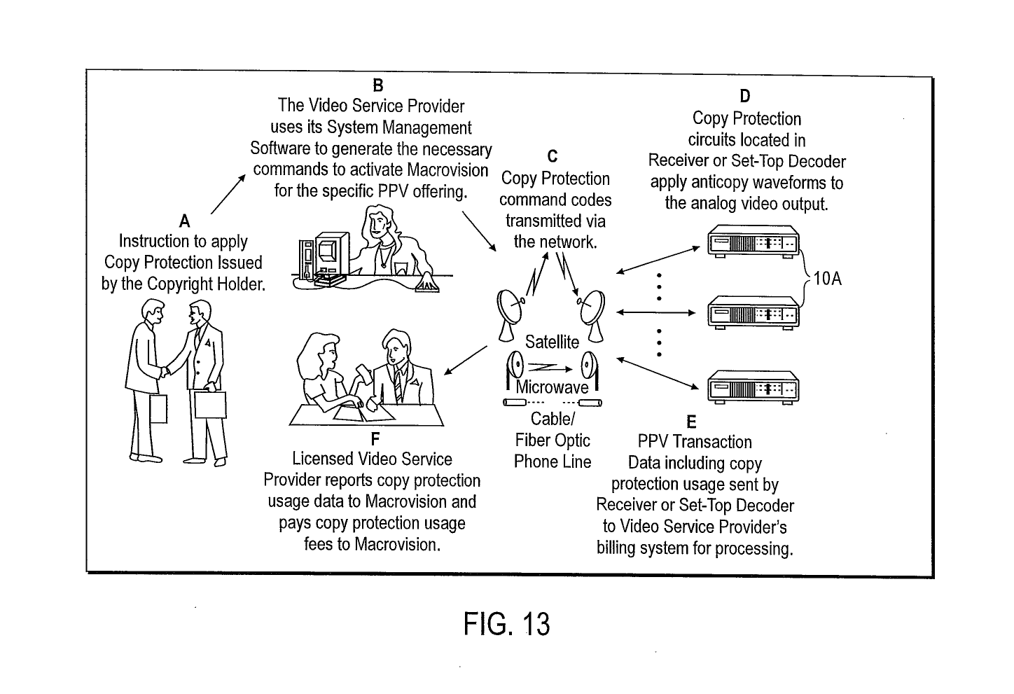

FIG. 13 illustrates a control and tracking method and system for enabling and controlling the application of copy protection of video signals and the like via digital video networks. Station A represents the issuance of instructions to video service providers by program rights holders who hold the copyrights, for the application by the providers of copy protection to the programs which are protected by pay-per-view (PPV) or pay-to-tape (PTT) requirements.

Station B depicts a control and billing center of the licensed video service providers who supply copy protection control software for the respective protected programs being broadcast, to generate the commands required to activate, control and reconfigure the copy protection process for each specific PPV/PTT program offering. Although a single provider is depicted, it is understood that station B represents any plurality of video service providers each with their respective proprietary control and tracking (billing) software, in accordance with the present invention.

Station C represents the procedure of transmitting the particular copy protection command codes of the respective providers, for the PPV/PTT program offerings, via the typical broadcasting networks. Such transmissions may be made by satellite, by microwave, by phone line or by cable transmission systems as depicted.

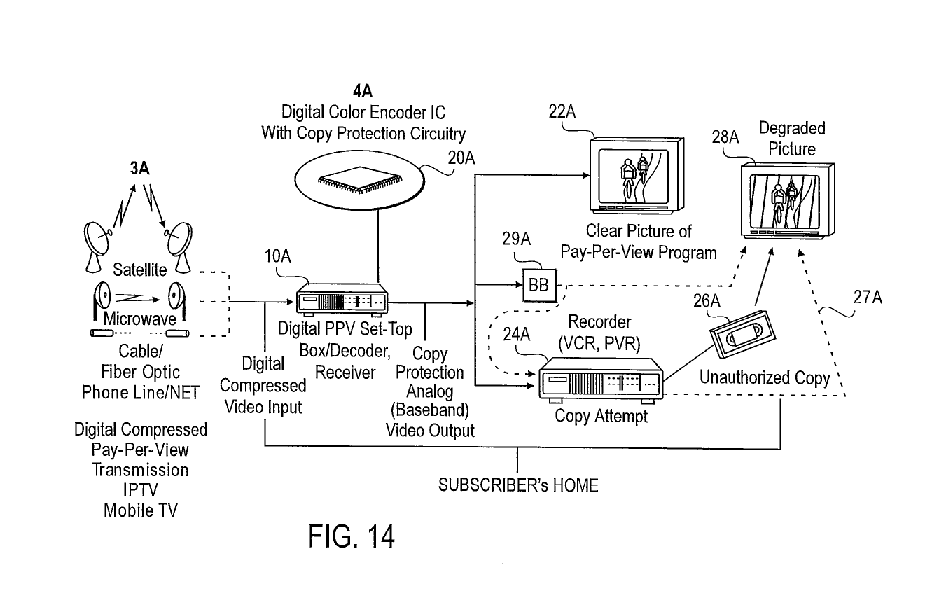

Station D represents the subscriber's home, or other receiving facility, and includes a set-top box 10A for each of a multitude of subscribers. Each set-top box contains copy protection circuitry including a digital color encoder integrated chip (IC), which is adapted to apply selected anticopy waveforms to the analog or digital video signal which is supplied therefrom to a television set or monitor. The receiving facility is further described in FIG. 14.

Station E represents the procedure whereby data identifying each PPV or PTT transaction, including copy protection usage, is sent by the set-top box 10A back through the transmission networks of station C, generally to the respective video service provider's control and billing (tracking) center. The center includes billing procedures which are a subset of the system control software and which process the return transaction data to provide for billing the subscriber for the PPV or PTT transaction usage.

Station F represents the procedure whereby each of the licensed video service providers report the copy protection usage to the program rights holder, whereby the provider pays the copy protection fees to the rights holder, i.e., the licensor.

FIG. 14 illustrates in further detail the subscriber's facility, station D of FIG. 13, receiving the digital, and usually compressed, pay-per-view transmissions from the broadcasting networks depicted as station C of FIG. 13. The compressed digital video signal, or the like, is supplied to the respective set-top box 10A of a multitude of set-top boxes, wherein each box includes conventional circuits for converting and decoding the digital compressed video signal to an analog (baseband) video signal. The set-top box 10A also includes a digital color encoder IC 20A of previous mention which contains copy protection circuitry for applying the selected copy protection waveforms to the analog (or digital) video signal, namely, the programs which are being protected. In this example, the copy protected analog baseband video is supplied by the set-top box to a TV set 22A where the pay-per-view protected program clearly is displayed for viewing if the subscriber is authorized to view the program. If the subscriber is not authorized for a particular PPV protected program, the corresponding picture is modified so as to be un-viewable.

In the event a subscriber records the PPV protected program via a VCR 24A to obtain a taped copy 26A without authorization, the unauthorized copy will be degraded to the degree that it is un-watchable, as depicted by a TV set 28A. In another example, recorder 24A may be a compliant recorder (e.g., a recorder with a content control system), and upon reading video signal modifications from set-top box 10A, the recorder 24A may shut down recording, limit recording, and or provide an altered resolution or quality in recording (dashed line 27A). However, if the subscriber subscribes to a pay-to-tape or pay to record transaction and to the required higher PTT transaction fee, then the copy is authorized and the resulting (taped or recorded) copy would readily be watchable.

FIG. 14 also shows an example of a circumvention device, BB (Black Box) 29A whose input is coupled to the output of set-top box 10A, and whose output is coupled to TV monitor/receiver 28A or to recorder 24A. In this example, the circumvention device will produce and supply a degraded signal or image (e.g., color problem or distortion and or blanked portion of active TV line(s) in the top of the active TV field) to the monitor 28A, because the black box 29A responds to the copy protection or content control signals from set-top box 10A as to cause the circumvention device to (unwittingly) enhance (and or pass/allow) the content control or copy protection signals from set-top box 10A. Accordingly, should the output of circumvention device 29A be coupled to recorder 24A, the recorder will still produce a poor copy or cause the recorder 24A to limit recording, shut down recording, or produce an altered resolution TV signal.

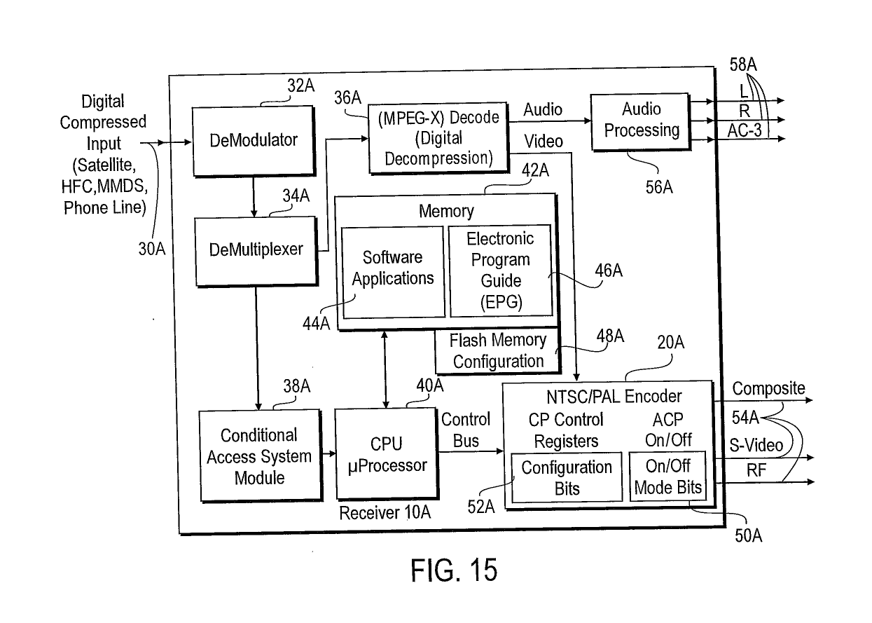

Referring to FIG. 15, there is illustrated in further detail an architecture of the set-top box(es) 10A of FIGS. 13, 14. Upon power up of the set-top box 10A, the configuration bits stored in flash memory 48A are read and written into the appropriate CP control registers 52A in the NTSC/PAL encoder 20A. When the compressed digital video signal, including the copy protection control commands of previous and following discussion, are supplied by the delivery network of previous mention (satellite, HFC, MMDS, phone line) to a demodulator circuit 32A, as depicted by an input lead 30A. The demodulated video/audio and control signals are supplied to a demultiplexer circuit 34A where the video/audio signals are separated into respective channels and supplied to an MPEG-2 decoder and digital decompression circuit 36A. The copy protection control commands are supplied from the demultiplexer 34A to a conditional access system module 38A. The commands are supplied to a microprocessor in a CPU 40A. The CPU processes information located in memory that is associated with the Electronic Program Guide (EPG) 46A or runs the copy protection application software 44A residing in memory 42A to deliver the activation command to the NTSC/PAL encoder 20A. The EPG may also have data which is used to determine if copy protection should be activated. There are additional methods that may be employed to activate copy protection.

In response to the control commands, the CPU 40A supplies control signals to the NTSC/PAL encoder IC 20A of previous mention, FIG. 14. The encoder IC 20A includes copy protection control registers 50A, 52A for receiving the mode bits and configuration control bits respectively, of previous and following discussion. The configuration bits 52A determine the form of the copy protection (i.e., where the pseudo sync and AGC pulses will be located or positions of the colorstripe lines etc.) The on/off/mode byte 50A determines which components of the copy protection process will be activated. See table 1 below. The encoder IC 20A also receives decompressed video from the MPEG-2 decoder and digital decompression circuit 36A. Encoder IC 20A outputs a RF signal, a composite video signal and/or an S-video signal via video leads 54A. The decompressed audio signal is supplied from the circuit 36A to an audio processing circuit 56A which, in turn, outputs left and right channel stereo signals and/or an AC-3 signal on audio leads 58A.

TABLE 1
Mode Control Bit Listing
Routine On/Off and Mode Selection

| NO | On/off and mode control; 8 bits | | |
|---|---|---|---|
| NO[7] | Reserved | | CPC0[3] |
| NO[6] | Pay-to-tape allowed/prohibited | (Allowed = 1, | CPC0[2] |
| | | Default = 0) | |
| NO[5] | VBI pulses On/Off (VBIP) | (ON = 1) | CPC0[1] |
| NO[4] | End of Field Back Porch Pulses | (ON = 1) | CPC0[0] |
| | on/off (EOFP) | | |
| NO[3] | Colorstripe process On/Off (CSP) | (ON = 1) | CPC1[3] |
| NO[2] | AGC pulse normal (amplitude | (Cycling = | CPC1[2] |
| | cycling)/static mode select | Default = 1) | |
| | (AGCY) | | |
| NO[1] | H-sync amplitude reduction | (ON = 1) | CPC1[1] |
| | On/Off (HAMP) | | |
| NO[0] | V-sync amplitude reduction | (ON = 1) | CPC1[0] |
| | On/Off (VAMP) | | |

It is preferred that the anticopy process on/off control is achieved by setting all the individual parameter on/off and mode control bits rather than a master on/off control. This requires that the NO (N-zero) bits in the control bit listing be set as required. Depending on the individual system, this will require the control of from 5 to 8 bits.

The delivery of the mode byte to the set-top box to activate or deactivate the copy protection process may be accomplished in several ways. Each method has its positive aspects as well as its negative aspects. When selecting a mechanism to control the copy protection technology, a service provider selects one of the following means or may develop an entirely new means.

One method may be for the mode byte to be delivered via the conditional access system via the entitlement control message (ECM). Another method might be to include the mode byte in a private data field in the MPEG transport data stream.

Another method may deliver the mode byte in a user defined section of the electronic program guide (EPG 46A) that is not identified in released documentation as controlling copy protection. This method also requires some additional security to keep the memory location of the mode byte from being accessed for unauthorized changes and the setting of a return flag that indicates the actual status of the mode byte when transmitted to the NTSC encoder (20A).

Another method may be a combination of the conditional access ECM and EPG. The transport of the mode byte in the EPG could be combined with two bits within the ECM. To activate the copy protection technology then would require an OR operation between the ECM bits and the EPG bits. If either is set, the copy protection technology, both ECM and EPG would have to indicate that deactivation is necessary.

Table 2 below shows an example of pay-to-tape control options for video programs such as pay-per-view Programs. Note that pay to tape is an equivalence to pay to record. For example, a tape recorder may be equivalently replaced with a recorder (e.g., disk recorder, solid state memory recorder, optical media recorder, magnetic media recorder).

TABLE 2
Pay-per-view and Pay-to-tape Control
Options for Pay-per-view Programs

| | Consumer | |
|---|---|---|
| | Request | |
| Program Descriptor of | (Pay-per-view | |
| PPV Program | or Pay-to-tape) | Result |
| Copy protection NOT | N/A | ACP off |
| required | | |
| Copy protection | Pay-per-view | ACP will be ON. |
| REQUIRED | | Pay-per-view transaction |
| Taping NOT permitted | | cost incurred by consumer. |
| Copy protection | Pay-to-tape | Requested option not |
| REQUIRED | | available. |
| Taping NOT permitted | | ACP will be ON. |
| | | Pay-per-view transaction |
| | | cost incurred by consumer. |
| Copy protection | Pay-per-view | ACP will be turned ON by |
| REQUIRED | | STB control system. |
| Taping permitted (at | | Pay-per-view transaction |
| higher transaction cost) | | cost incurred by consumer. |
| Copy protection | Pay-to-tape | ACP will be turned OFF by |
| REQUIRED | | STB control system. |
| Taping permitted (at | | Pay-to-tape transaction |
| higher transaction cost) | | cost incurred by consumer. |

A summary of one or more embodiment of the invention includes a copy protection signal from a receiving device that improves geometric distortion for better playability, a copy protection signal that reduces or defeats the function of a circumvention device, and or a copy protection signal from a receiving device that triggers or causes a circumvention device to enhance copy protection effect(s). Such copy protection signals may be utilized in a receiving device as follows:

A receiving device which comprises;
a digital to analog converter coupled to a source of digitally recorded material for providing an analog video signal from a digital signal, a signal sensing or reader circuit for detecting or reading copy protection or content control bit(s), and a signal generator for generating an analog copy protection signal at the output of the digital to analog converter in response to the copy protection or content control bit(s).

One or more embodiments of the invention includes any of the following characteristics:

When the copy protection signal is supplied via an analog output of the receiving device to an input of the circumvention device, and wherein the output of the circumvention device passes at least part of the copy protection signal sufficiently for a copy protection or content control effect, and or wherein the output of the circumvention device provides a signal to further distort or blank a portion of an active TV field.

When the copy protected video signal from the receiving device is coupled to an input of the circumvention device, the output of the circumvention device supplies a signal that is substantially effective in terms of copy protection or content control for a video recorder or for a content control system.

A circuit for inserting or adding in at least one TV line one or more pseudo sync pulses or one or more pseudo sync (pulse)/AGC pulse pair signals immediately after or less than two or two and a half lines after a vertical sync signal or post equalizing pulse (e.g., in an odd field, even field, or both fields).

A method of providing a different number of pseudo sync pulses from one video line to another video line and or different pseudo sync pulse widths from one video line to another, generating at least two lines consecutively with substantially the same number of pseudo sync pulses and or substantially the same pseudo sync pulse width (e.g., for improved playability).

When a copy protected video signal is supplied to a TV set via an analog output of the receiving device, improved playability is achieved via reduced hooking on a top portion of the TV.

A method of starting or providing pseudo sync pulses immediately after or less than 2 or 2.5 lines after a vertical sync signal or post equalizing pulse to provide the copy protection signal at an analog output of the receiving device, may include one or more of the following: a color burst modification of whole or segmented portions of one or more color burst envelope which includes one or more cycle of incorrect color burst, level shifting of a portion of the video signal including lowering or raising one or more portions of the video signal, modifying sync location, amplitude, and or pulse width in selected video lines, providing back porch pulses of different video levels from one video line to another, providing pseudo sync and or AGC pulses of different pulse widths from one video line to another, providing pseudo sync and or AGC pulses of different numbers from one video line to another.

When the copy protection signal is supplied via an analog output of the receiving device to an input of the circumvention device, wherein the output of the circumvention device passes at least part of the copy protection signal sufficiently for a copy protection or content control effect, and or wherein the output of the circumvention device provides a signal to (further) distort or blank a portion of an active TV field.

Combining pseudo sync and or pseudo sync and automatic gain control (AGC) pulses immediately after a vertical sync signal or less than two or two and a half video lines after a vertical sync signal or post equalizing pulse, with the color burst modification (e.g. color stripe, partial color stripe), which in combination is generated at an analog output of the receiving device, wherein the color burst modification includes cycles of incorrect phase or frequency in selected video lines, wherein the analog output of the receiving device is coupled to an input of the circumvention device, and wherein outputting via the circumvention device a copy protection signal which produces color distortions in the modified color burst of the copy protection signal and extra color distortion due to blanking or modifying of color burst envelopes in an active video field caused by the circumvention device.

It should be noted that a receiving device by default may provide one or more copy protection or content control signal as previously mentioned when power is applied to the device. In another embodiment of the invention a receiver may produce a partial or no copy protection or content control signal upon power-up, until a network signal (e.g., IPTV, WiMax, WiFi, phone, RF, TV, DTV, HDTV, optical, Internet, router signal, signal from a computer, or the like), or transmission, is received in the device. Here for example, one or more copy protection or content control signal is provided (e.g., to provide a more complete or effective copy protection or content control signal by a video signal) upon reception of a signal by the receiver.

This disclosure is illustrative and not limiting. Further modifications will be apparent to those skilled in the art in light of this disclosure and are intended to fall within the scope of the appended claims.

What is claimed is:

1. A receiver for providing a video copy protection signal for a video signal to form a copy protected video signal which causes a circumvention device to pass substantially the copy protected video signal at the output of the circumvention device, the receiver comprising:
a circuit for inserting or adding in at least one TV line one or more pseudo sync pulses or one or more pseudo sync pulse/AGC pulse pair signals immediately after or less than two lines after a vertical sync signal or post equalizing pulse to form the copy protected video signal; and
wherein when the copy protected video signal from the receiver is coupled to an input of the circumvention device, the output of the circumvention device supplies a signal that is substantially effective in terms of copy protection or content control for a video recorder or for a content control system.

2. The receiver of claim 1 wherein the at least one TV line includes up to 18 TV lines.

3. The receiver of claim 1 wherein the copy protected video signal is a PAL or NTSC or SECAM copy protected video signal.

4. The receiver of claim 1 wherein the circumvention device adds or enhances copy protection effectiveness after processing the copy protected video signal.

5. The receiver of claim 1 wherein the circumvention device further blanks or distorts a portion of the active video field.

6. The receiver of claim 1 wherein the circumvention device further blanks out color burst signals in one or more TV lines in the active TV field.

7. The receiver of claim 6 wherein one or more TV lines in the active TV field exhibit color distortion.

8. The receiver of claim 1 wherein the copy protected video signal provides improved playability when compared to a copy protected video signal which starts inserting pseudo sync pulses two or more lines after the vertical sync signal.

9. The receiver of claim 1 wherein the copy protection video signal enhances copy protection by causing the circumvention device to attenuate and or level shift at least one TV line of the active field.

10. The receiver of claim 1 wherein the copy protection video signal provides reduced geometric distortion in a display of the copy protected video signal.

11. The receiver of claim 1 wherein the pseudo sync pulses have a different number of pseudo sync pulses from one line to another or a different pseudo sync pulse width from one line to another line.

12. A method of providing a copy protected video signal from a receiver while providing improved playability of the copy protected video signal, wherein the copy protected video signal includes pseudo sync pulses, comprising:
providing a different number of pseudo sync pulses from one video line to another video line and or different pseudo sync pulse widths from one video line to another;
generating at least two lines consecutively with substantially the same number of pseudo sync pulses and or substantially the same pseudo sync pulse width; and
wherein when the copy protected video signal is supplied to a TV set via an analog output of the receiver, it causes improved playability via reduced hooking on a top portion of the TV.

13. A method of providing a copy protection signal from a receiver having pseudo sync and automatic gain control (AGC) pulses defining a pulse pair signal, wherein a location of the pseudo sync pulses provides resistance to a circumvention device and wherein the circumvention device passes at least one pulse pair signal, comprising:
starting the pseudo sync pulses immediately after or less than 2 lines after a vertical sync signal or post equalizing pulse to provide the copy protection signal at an analog output of the receiver; and
the method including one or more of the following; a color burst modification of whole or segmented portions of one or more color burst envelope which includes one or more cycle of incorrect color burst, level shifting of a portion of the video signal including lowering or raising one or more portions of the video signal, modifying sync location, amplitude, and or pulse width in selected video lines, providing back porch pulses of different video levels from one video line to another, providing pseudo sync and or AGC pulses of different pulse widths from one video line to another, providing pseudo sync and or AGC pulses of different numbers from one video line to another.

14. A method of providing a copy protection signal in a video signal via a receiver, wherein the copy protection signal causes a circumvention device to modify the video signal to increase copy protection effectiveness, the method comprising:
starting the copy protection signals immediately after a vertical sync signal or less than two lines after a vertical sync signal or after a post equalizing pulse to provide the copy protection signal; and
wherein when the copy protection signal is supplied via an analog output of the receiver to an input of the circumvention device, the output of the circumvention device passes at least part of the copy protection signal sufficiently for a copy protection or content control effect, and/or the output of the circumvention device provides a signal to further distort or blank a portion of an active TV field.

15. A method of providing increased color copy protection effects in a copy protection signal provided by a receiver to a circumvention device, wherein the copy protection signal includes color burst modification in selected video lines, and wherein the color burst modification causes a recorder to produce color distortion, comprising:
combining pseudo sync and or pseudo sync and automatic gain control (AGC) pulses immediately after a vertical sync signal or less than two video lines after a vertical sync signal or post equalizing pulse, with the color burst modification, which combination is generated at an analog output of the receiver;
wherein the color burst modification includes cycles of incorrect phase or frequency in selected video lines; and
wherein the analog output of the receiver is coupled to an input of the circumvention device; and
wherein outputting via the circumvention device a copy protection signal produces color distortions in the modified color burst of the copy protection signal and extra color distortion due to blanking or modifying of color burst envelopes in an active video field caused by the circumvention device.

16. A method of providing a video copy protection signal from a receiver utilizing pseudo sync or pseudo sync and AGC pulses, comprising:
providing pseudo sync pulses and automatic gain control (AGC) pulses to form pulse pair signals in a portion of the vertical blanking interval, wherein the number of pseudo sync and AGC pulses alternates from one video line to a next video line, and wherein there is at least two adjacent lines that have a different number of pseudo sync and AGC pulses, wherein at least the last two video lines are provided with the same number of pseudo sync and AGC pulses;
wherein the step of providing provides the video copy protection signal which is supplied via an analog output of the receiver; and
wherein the video copy protection signal is improved in playability on a TV monitor when compared with a copy protection signal that has alternating numbers of pseudo sync pulses from one video line to another.

17. The method of claim 16 wherein the video copy protection signal occupies at least three video lines, including two adjacent video lines with a different number of pseudo sync pulses per line, and including two consecutive video lines with the same number of pseudo sync pulses per line.

18. A receiver for providing a video copy protection signal with improved playability, wherein a number of pseudo sync pulses, or pseudo sync and automatic gain control (AGC) pulses, alternate from one video line to another video line, and wherein there is at least two adjacent video lines that have a different number of pseudo sync or pseudo sync and AGC pulses, the receiver comprising:
a circuit for providing at least the last two video lines of the video copy protection signal with the same number of pseudo sync or pseudo sync and AGC pulses to provide the video copy protection signal of improved playability; and
wherein the playability of the latter copy protected signal on a television monitor is improved when compared to a copy protection signal that has an alternating number of pseudo sync or pseudo sync and AGC pulses from one video line to another.

19. A method of providing a video copy protection signal from a receiver, wherein the number of pseudo sync and automatic gain control (AGC) pulses alternates from one video line to a next line, and wherein there is at least two video lines adjacent that have a different number of pseudo sync and AGC pulses, comprising:
providing pseudo sync pulses and AGC pulses to form pulse pair signals in a portion of the vertical blanking interval, wherein at least the last two lines are provided the same number of pseudo sync and AGC pulses to improve playability on a TV monitor, wherein the video copy protection signal is improved in playability when compared with a copy protection signal that has alternating numbers of pseudo sync pulses from one video line to another.

20. The method of claim 19 wherein the video copy protection signal occupies at least three TV lines including two adjacent lines with different number of pseudo sync pulses per line and including two consecutive lines with the same number of pseudo sync pulses per line.

21. A receiver for playing back a digital recording and for providing an analog copy protection signal which causes a circumvention device to pass substantially the analog video copy protection signal at the output of the circumvention device, the receiver comprising:
a signal detector or encoder for detecting or encoding copy protection information present in the digital recording;
a digital to analog converter (DAC) receiving the digital recording for outputting an analog signal; and
a signal generator for generating a copy protection signal in response to the signal detector or encoder and for modifying the analog signal output from the DAC with the generated copy protection signal, to provide the analog copy protection signal at the output of the circumvention device.
